(19) United States
(12) Patent Application Publication
(10) Pub. No.: US 2003/0003396 A1
(43) Pub. Date: Jan. 2, 2003

(54) Optical data carrier comprising a merocyanine dye as light-absorbent compound in the information layer

(76) Inventors: Horst Berneth, Leverkusen (DE); Friedrich-Karl Bruder, Krefeld (DE); Wilfried Haese, Odenthal (DE); Rainer Hagen, Leverkusen (DE); Karin Hassenruck, Dusseldorf (DE); Serguei Kostromine, Swisttal (DE); Peter Landenberger, Koln (DE); Rafael Oser, Krefeld (DE); Thomas Sommermann, Gladbach (DE); Josef-Walter Stawitz, Odenthal (DE); Thomas Bieringer, Odenthal (DE)

Correspondence Address: BAYER CORPORATION, PATENT DEPARTMENT, 100 BAYER ROAD, PITTSBURGH, PA, 15205, US

(21) Appl. No.: 10/102,571

(22) Filed: Mar. 20, 2002

(30) Foreign Application Priority Data
Mar. 28, 2001 (DE) 10115227.2
Apr. 6, 2001 (DE) 10117464.0

(51) Int. Cl. G11B 7/24

(52) U.S. Cl. 430/270.18; 430/270.15; 430/19; 430/945; 428/64.8; 428/913; 428/914

(57) ABSTRACT

Optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that at least one merocyanine dye is used as light-absorbent compound.

The invention relates to a write-once optical data carrier comprising a merocyanine dye as light-absorbent compound in the information layer, to a process for its production and also to the application of the above-mentioned dyes to a polymer substrate, in particular polycarbonate, by spin coating or vapour deposition.

Write-once optical data carriers using specific light-absorbent substances or mixtures thereof are particularly suitable for use in high-density writeable optical data stores which operate with blue laser diodes, in particular GaN or SHG laser diodes (360-460 nm) and/or for use in DVD-R or CD-R disks which operate with red (635-660 nm) or infrared (780-830 nm) laser diodes.

The write-once compact disk (CD-R, 780 nm) has recently experienced enormous volume growth and represents the technically established system.

The next generation of optical data stores—DVDs—is currently being introduced onto the market. Through the use of shorter-wave laser radiation (635-660 nm) and higher numerical aperture NA, the storage density can be increased. The writeable format in this case is DVD-R.

Today, optical data storage formats which use blude laser diodes (based on GaN, JP 08 191 171 or Second Harmonic Generation SHG JP 09 050 629) (360 nm-460 nm) with high laser power are being developed. Writeable optical data stores will therefore also be used in this generation. The achievable storage density depends on the focussing of the laser spot on the information plane. Spot size scales with the laser wavelength λ/NA. NA is the numerical aperture of the objective lens used. In order to obtain the highest possible storage density, the use of the smallest possible wavelength λ is the aim. At present 390 nm is possible on the basis of semiconductor laser diodes.

The patent literature describes dye-based writeable optical data stores which are equally suitable for CD-R and DVD-R systems (JP-A 11 043 481 and JP-A 10 181 206). To achieve a high reflectivity and a high modulation height of the read-out signal and also to achieve sufficient sensitivity in writing, use is made of the fact that the IR wavelength of 780 nm of CD-Rs is located at the foot of the long wavelength flank of the absorption peak of the dye and the red wavelength of 635 nm or 650 nm of DVD-Rs is located at the foot of the short wavelength flank of the absorption peak of the dye. In JP-A 02 557 335, JP-A 10 058 828, JP-A 06 336 086, JP-A 02 865 955, WO-A 09 917 284 and U.S. Pat. No. 5,266,699, this concept is extended to the 450 nm working wavelength region on the short wavelength flank and the red and IR region on the long wavelength flank of the absorption peak.

Apart from the abovementioned optical properties, the writeable information layer comprising light-absorbent organic substances has to have a substantially amorphous morphology to keep the noise signal during writing or reading as small as possible. For this reason, it is particularly preferred that crystallization of the light-absorbent substances be prevented in the application of the substances by spin coating from a solution, by vapour deposition and/or sublimation during subsequent covering with metallic or dielectric layers under reduced pressure.

The amorphous layer comprising light-absorbent substances preferably has a high heat distortion resistance, since otherwise further layers of organic or inorganic material which are applied to the light-absorbent information layer by sputtering or vapour deposition would form blurred boundaries due to diffusion and thus adversely affect the reflectivity. Furthermore, a light-absorbent substance which has insufficient heat distortion resistance can, at the boundary to a polymeric support, diffuse into the latter and once again adversely affect the reflectivity.

A light-absorbent substance whose vapour pressure is too high can sublime during the above-mentioned deposition of further layers by sputtering or vapour deposition in a high vacuum and thus reduce the layer thicknes to below the desired value. This in turn has an adverse effect on the reflectivity.

It is therefore an object of the invention to provide suitable compounds which satisfy the high requirements (e.g. light stability, favourable signal/noise ratio, damage-free application to the substrate material, and the like) for use in the information layer in a write-once optical data carrier, in particular for high-density writeable optical data store formats in a laser wavelength range from 340 to 830 nm.

Surprisingly, it has been found that light-absorbent compounds selected from the group of merocyanine dyes can satisfy the abovementioned requirement profile particularly well.

The invention accordingly provides an optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that at least one merocyanine dye is used as light-absorbent compound.

The light-absorbent compound should preferably be able to be changed thermally. The thermal change preferably occurs at a temperature of <600° C., particularly preferably at a temperature of <400° C., very particularly preferably at a temperature of <300° C., in particular <200° C. Such a change can be, for example, a decomposition or chemical change of the chromophoric centre of the light-absorbent compound.

Preference is given to a merocyanine dye of the formula

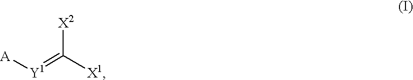

where

A represents a radical of the formula

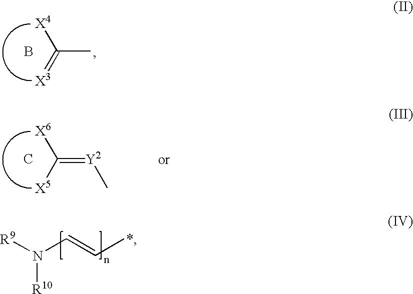

X¹ represents CN, CO—R¹, COO—R¹, CONHR³, CONR³R⁴ or SO₂R¹,

X² represents hydrogen, C₁-C₆-alkyl, C₆-C₁₀-aryl, a five- or six-membered heterocyclic radical, CN, CO—R¹, COO—R², CONHR³, CONR³R⁴, SO₂R¹ or a radical of the formula

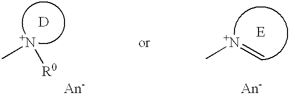

or

CX¹X² represents a ring of the formula

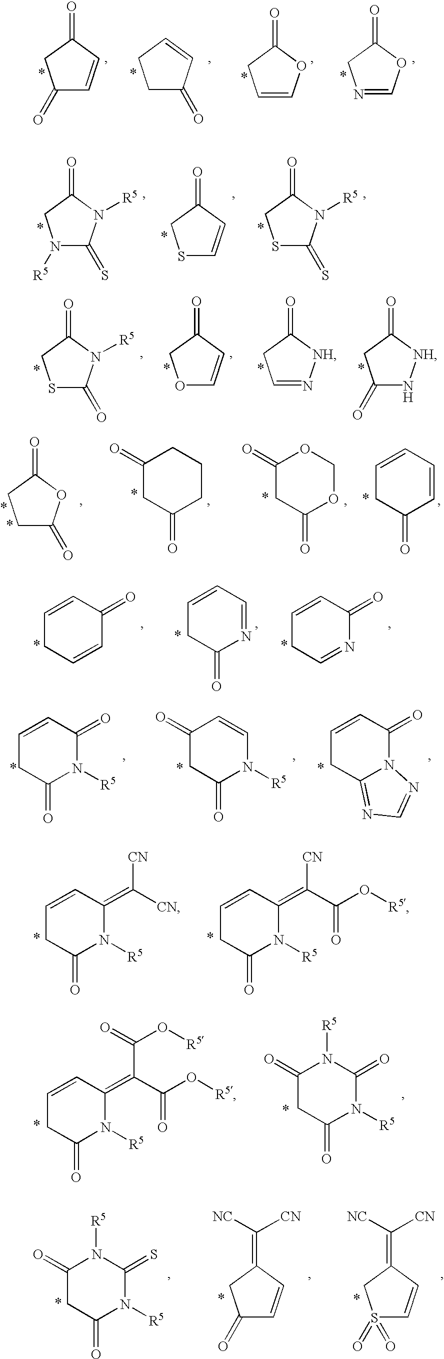

which may be benzo- or naphtho-fused and/or substituted by nonionic or ionic radicals, where the asterisk (*) indicates the ring atom from which the double bond extends,

X³ represents N or CH,

X⁴ represents O, S, N, N—R⁶ or CH, where X³ and X⁴ do not simultaneously represent CH,

X⁵ represents O, S or N—R⁶,

X⁶ represents O, S, N, N—R⁶, CH or CH₂,

the ring B of the formula (II)

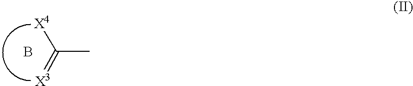

together with X⁴, X³ and the C atom between them

and the ring C of the formula (V)

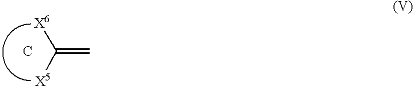

together with X⁵, X⁶ and the C atom between them

each represent, independently of one another, a five- or six-membered aromatic, pseudoaromatic or partially hydrogenated heterocyclic ring which can contain from 1 to 4 heteroatoms and/or may be benzo- or naphtho-fused and/or substituted by nonionic or ionic radicals,

the ring D together with the N atom represents a hydrogenated five- or six-membered heterocyclic ring which can contain from 1 to 4 heteroatoms and/or may be substituted by nonionic or ionic radicals,

the ring E together with the N atom represents an aromatic, pseudoaromatic or partially hydrogenated five- or six-membered heterocyclic ring which can contain from 1 to 4 heteroatoms and/or may be benzo- or naphtho-fused and/or substituted by nonionic or ionic radicals,

An⁻ represents an anion,

Y¹ represents N or C—R⁷,

Y² represents N or C—R⁸,

R⁰ represents C₁-C₆-alkyl or C₇-C₁₅-aralkyl,

R¹ to R⁶ and R^{5′} represent, independently of one another, hydrogen, C₁-C₆-alkyl, C₃-C₆-alkenyl, C₅-C₇-cycloalkyl, C₆-C₁₀-aryl or C₇-C₁₅-aralkyl,

R⁷ and R⁸ represent, independently of one another, hydrogen, cyano or C₁-C₆-alkyl or

R⁶ and R⁸ together represent a CH₂)₂— or —(CH₂)₃— bridge,

R⁹ and R¹⁰ represent, independently of one another, C₁-C₆-alkyl, C₆-C₁₀-aryl, a five- or six-membered heterocyclic radical or C₇-C₁₅-aralkyl or

NR⁹R¹⁰ may form a five- or six-membered ring and

n represents 1 or 2.

Possible nonionic radicals are, for example, C₁-C₄-alkyl, C₁-C₄-alkoxy, halogen, cyano, nitro, C₁-C₄-alkoxycarbonyl, C₁-C₄-alkylthio, phenyl, pyridyl, C₁-C₄-alkanoylamino, benzoylamino, mono- or di-C₁-C₄-alkylamino, pyrrolidino, piperidino, piperazino or morpholino.

Possible ionic radicals are, for example, ammonium radicals or COO⁻ or SO₃⁻ radicals which may be bound via a direct bond or via —(CH₂)ₙ—, where n represents an integer from 1 to 6.

Alkyl, alkoxy, aryl and heterocyclic radicals may, if desired, bear further radicals such as alkyl, halogen, nitro, cyano, CO—NH₂, alkoxy, trialkylsilyl, trialkylsiloxy or phenyl, the alkyl and alkoxy radicals may be straight-chain or branched, the alkyl radicals may be partially halogenated or perhalogenated, the alkyl and alkoxy radicals may be ethoxylated or propoxylated or silylated, adjacent alkyl and/oder alkoxy radicals on aryl or heterocyclic radicals may together form a three- or four-membered bridge and the heterocyclic radicals may be benzo-fused and/or quaternized.

Preference is given to

the ring B of the formula (II) representing furan-2-yl, thiophen-2-yl, pyrrol-2-yl, benzofuran-2-yl, benzothiophen-2-yl, thiazol-5-yl, imidazol-5-yl, 1,3,4-thiadiazol-2-yl, 1,3,4-triazol-2-yl, 2- or 4-pyridyl, 2- or 4-quinolyl, where the individual rings may be substituted by C₁-C₆-alkyl, C₁-C₆-alkoxy, fluorine, chlorine, bromine, iodine, cyano, nitro, C₁-C₆-alkoxycarbonyl, C₁-C₆-alkylthio, C₁-C₆-acylamino, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino or piperidino, and

the ring C of the formula (V) representing benzothiazol-2-ylidene, benzoxazol-2-ylidene, benzimidazol-2-ylidene, pyrrolin-2-ylidene, thiazol-2-ylidene, thiazolin-2-ylidene, isothiazol-3-ylidene, isoxazol-3-ylidene, oxazolin-2-ylidene, imidazol-2-ylidene, pyrazol-5-ylidene, 1,3,4-thiadiazol-2-ylidene, 1,3,4-oxadiazol-2-ylidene, 1,2,4-thiadiazol-5-ylidene, 1,3,4-triazol-2-ylidene, 3H-indol-2-ylidene, dihydropyridin-2- or -4-ylidene, dihydroquinolin-2- or -4-ylidene, where the individual rings may be substituted by C₁-C₆-alkyl, C₁-C₆-alkoxy, fluorine, chlorine, bromine, iodine, cyano, nitro, C₁-C₆-alkoxycarbonyl, C₁-C₆-alkylthio, C₁-C₆-acylamino, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino or piperidino.

In a particularly preferred embodiment, the merocyanines used are ones of the formula (VI)

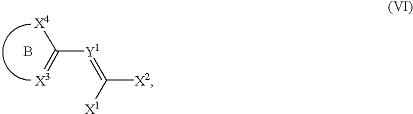

where

X¹ represents CN, CO—R¹, COO—R² or SO₂R¹,

X² represents hydrogen, methyl, ethyl, phenyl, 2- or 4-pyridyl, thiazol-2-yl, benzothiazol-2-yl, benzoxazol-2-yl, CN, CO—R¹, COO—R² or a radical of the formula

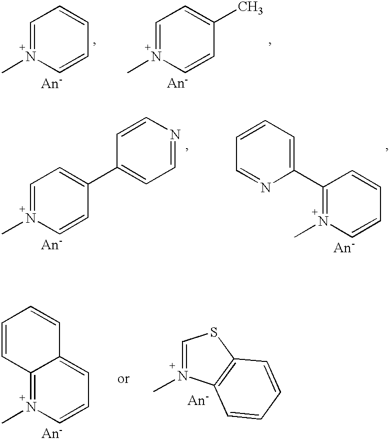

or

CX¹X² represents a ring of the formula

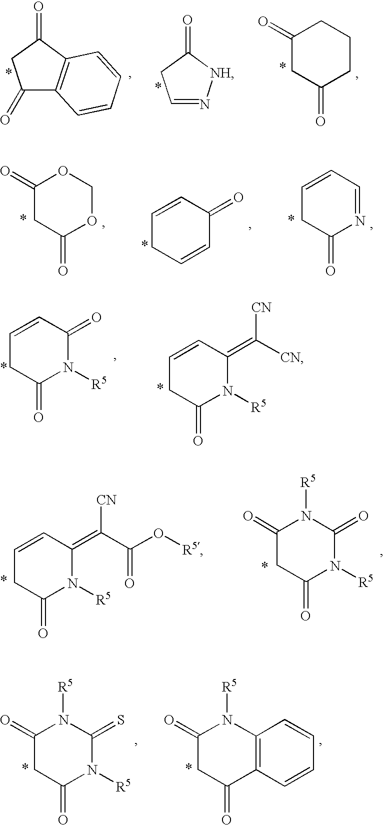

which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl,

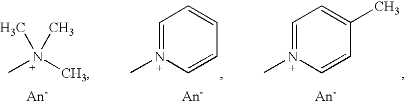

SO₃⁻M⁺, —CH₂—SO₃⁻M⁺,

where the asterisk (*) indicates the ring atom from which the double bond extends,

An⁻ represents an anion,

M⁺ represents a cation,

X³ represents CH,

X⁴ represents O, S or N—R⁶,

the ring B of the formula (II) represents furan-2-yl, thiophen-2-yl, pyrrol-2-yl or thiazol-5-yl, where the rings mentioned may each be substituted by methyl, ethyl, propyl, butyl, methoxy, ethoxy, fluorine, chlorine, bromine, cyano, nitro, methoxycarbonyl, ethoxycarbonyl, methylthio, ethylthio, phenoxy, tolyloxy, dimethylamino, diethylamino, dipropylamino, dibutylamino, N-methyl-N-phenylamino, pyrrolidino or morpholino,

Y¹ represents N or C—R⁷,

R¹, R², R⁵ and R⁶ represent, independently of one another, hydrogen, methyl, ethyl, propyl, butyl, pentyl, hexyl, phenyl or benzyl and

R⁵ may also represent —(CH₂)₃—N(CH₃)₂ or —(CH₂)₃—N⁺(CH₃)₃An⁻,

R^{5′} represents methyl, ethyl, propyl, butyl, pentyl, hexyl, phenyl or benzyl and

R⁷ represents hydrogen or cyano.

In a likewise particularly preferred embodiment, the merocyanines used are ones of the formula (VII)

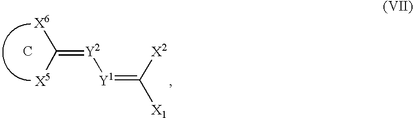

where

X¹ represents CN, CO—R¹, COO—R² or SO₂R¹,

X² represents hydrogen, methyl, ethyl, phenyl, 2- or 4-pyridyl, thiazol-2-yl, benzothiazol-2-yl, benzoxazol-2-yl, CN, CO—R¹, COO—R² or a radical of the formula

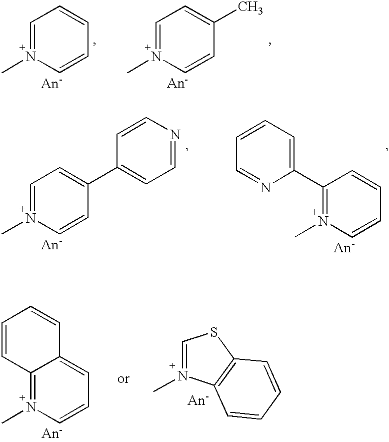

or

CX¹X² represents a ring of the formula

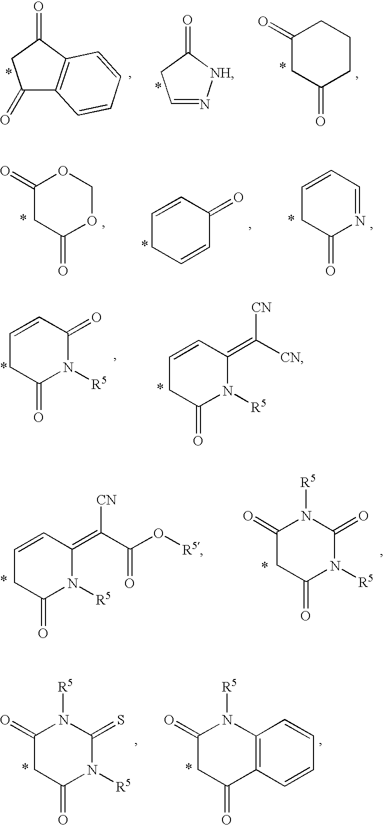

which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl,

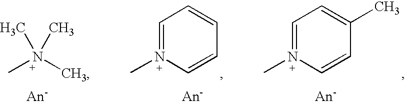

SO₃⁻M⁺, —CH₂—SO₃⁻M⁺,

where the asterisk (*) indicates the ring atom from which the double bond extends,

An⁻ represents an anion,

M⁺ represents a cation,

X⁵ represents N—R⁶,

X⁶ represents S, N—R⁶ or CH₂,

the ring C of the formula (V) represents benzothiazol-2-ylidene, benzimidazol-2-ylidene, thiazol-2-ylidene, thiazolin-2-ylidene, 1,3,4-thiadiazol-2-ylidene, 1,3,4-triazol-2-ylidene, dihydropyridin-4-ylidene, dihydroquinolin-4-ylidene, pyrrolin-2-ylidene or 3H-indol-2-ylidene, where the rings mentioned may each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,

Y²Y¹ represents N—N or (C—R⁸)—(C—R⁷),

R¹, R², R⁵ and R⁶ represent, independently of one another, hydrogen, methyl, ethyl, propyl, butyl, pentyl, hexyl, phenyl or benzyl and

R⁵ may also represent —(CH₂)₃—N(CH₃)₂ or —(CH₂)₃—N⁺(CH₃)₃An⁻,

R^{5′} represents methyl, ethyl, propyl, butyl, pentyl, hexyl, phenyl or benzyl,

R⁷ and R⁸ represent hydrogen or

R⁶ and R⁸ together represent a —CH₂—CH₂— bridge.

In a likewise particularly preferred embodiment, the merocyanines used are ones of the formula (VIII)

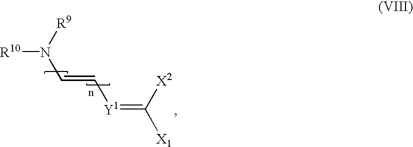

where

X¹ represents CN, CO—R¹, COO—R² or SO₂R¹,

X² represents hydrogen, methyl, ethyl, phenyl, 2- or 4-pyridyl, thiazol-2-yl, benzothiazol-2-yl, benzoxazol-2-yl, CN, CO—R¹, COO—R² or a radical of the formula

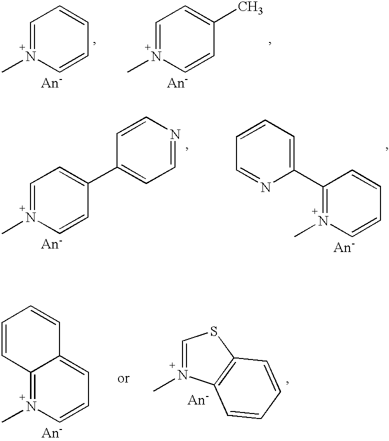

or

CX¹X² represents a ring of the formula

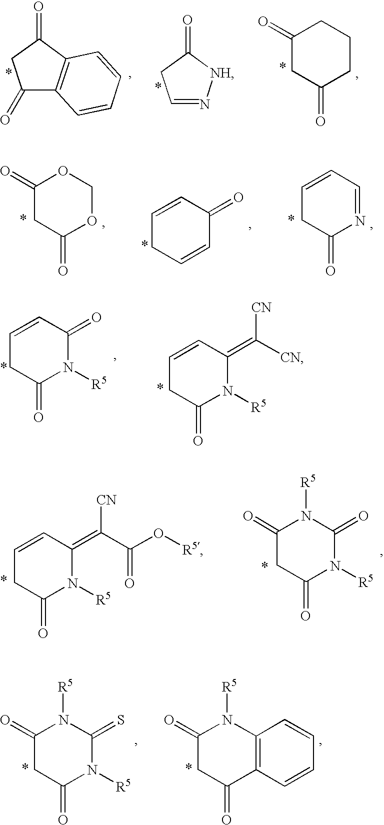

which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl,

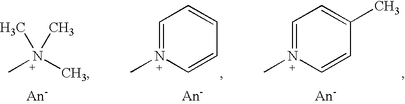

SO₃⁻M⁺, —CH₂—SO₃⁻M⁺,

where the asterisk (*) indicates the ring atom from which the double bond extends,

An⁻ represents an anion,

M⁺ represents a cation,

NR⁹R¹⁰ represents dimethylamino, diethylamino, dipropylamino, dibutylamino, N-methyl-N-phenylamino, N-ethyl-N-phenylamino, N-methyl-N-tolylamino, N-methyl-N-anisylamino, carbazolo, pyrrolidino, piperidino or morpholino,

Y¹ represents N or C—R⁷,

R¹, R², R⁵ and R⁶ represent, independently of one another, hydrogen, methyl, ethyl, propyl, butyl, pentyl, hexyl, phenyl or benzyl and

R⁵ may also represent —(CH₂)₃—N(CH₃)₂ or —(CH₂)₃—N⁺(CH₃)₃An⁻,

R^{5′} represents methyl, ethyl, propyl, butyl, pentyl, hexyl, phenyl or benzyl,

R⁷ represents hydrogen and

n represents 0 or 1.

Possible anions An⁻ are all monovalent anions or one equivalent of a polyvalent anion. Preference is given to colourless anions. Examples of suitable anions are chloride, bromide, iodide, tetrafluoroborate, perchlorate, hexafluorosilicate, hexafluorophosphate, methosulphate, ethosulphate, C₁-C₁₀-alkanesulphonate, C₁-C₁₀-perfluoroalkanesulphonate, unsubstituted or chlorine-, hydroxy- or C₁-C₄-alkoxy-substituted C₁-C₁₀-alkanoate, unsubstituted or nitro-, cyano-, hydroxy-, C₁-C₂₅-alkyl-, perfluoro-C₁-C₄-alkyl-, C₁-C₄-alkoxycarbonyl- or chloro-substituted benzene-sulphonate, naphthalenesulphonate or biphenylsulphonate, unsubstituted or nitro-, cyano-, hydroxy-, C₁-C₄-alkyl-, C₁-C₄-alkoxy-, C₁-C₄-alkoxycarbonyl- or chloro-substituted benzenedisulphonate, naphthalenedisulphonate or biphenyldisulphonate, unsubstituted or nitro-, cyano-, C₁-C₄-alkyl-, C₁-C₄-alkoxy-, C₁-C₄-alkoxycarbonyl-, benzoyl-, chlorobenzoyl- or toluoyl-substituted benzoate, the anion of naphthalenedicarboxylic acid, (diphenyl ether)disulphonate, tetraphenylborate, cyanotriphenylborate, tetra-C₁-C₂₀-alkoxyborate, tetraphenoxyborate, 7,8- or 7,9-dicarba-nido-undecaborate(1-) or (2-), which may, if desired, be substituted on the B and/or C atoms by one or two C₁-C₁₂-alkyl or phenyl groups, dodecahydro-dicarbadodecaborate(2-) and B-C₁-C₁₂-alkyl-C-phenyl-dodecahydro-dicarba-dodecaborate(1-).

Preference is given to bromide, iodide, tetrafluoroborate, perchlorate, methanesulphonate, benzenesulphonate, toluenesulphonate, dodecylbenzenesulphonate, tetradecanesulphonate.

Possible cations M⁺ are all monovalent cations or one equivalent of a polyvalent cation. Preference is given to colourless cations. Examples of suitable cations are lithium, sodium, potassium, tetramethylammonium, tetraethylammonium, tetrabutylammonium, trimethyl-benzylammonium, trimethyl-caprylammonium and Fe(C₅H₅)₂⁺ (where C₅H₅=cyclopentadienyl).

Preference is given to tetramethylammonium, tetraethylammonium, tetrabutylammonium.

In the case of a write-once optical data carrier according to the invention which is written on and read by means of the light of a blue laser, preference is given to merocyanine dyes whose absorption maximum λₘₐₓ₁ is in the range from 340 to 410 nm, where the wavelength λ_{1/2} at which the absorbance in the long wavelength flank of the absorption maximum at the wavelength λₘₐₓ₁ is half of the absorbance value at λₘₐₓ₁ and the wavelength λ_{1/10} at which the absorbance in the long wavelength flank of the absorption maximum at the wavelength λₘₐₓ₁ is one tenth of the absorbance value at λₘₐₓ₁ are preferably not more than 50 nm apart. Such a merocyanine dye preferably has no longer-wavelength maximum λₘₐₓ₂ up to a wavelength of 500 nm, particularly preferably up to 550 nm, very particularly preferably up to 600 nm.

Preference is given to merocyanine dyes having an absorption maximum λₘₐₓ₁ of from 345 to 400 nm.

Particular preference is given to merocyanine dyes having an absorption maximum λₘₐₓ₁ of from 350 to 380 nm.

Very particular preference is given to merocyanine dyes having an absorption maximum λₘₐₓ₁ of from 360 to 370 nm.

In the case of these merocyanine dyes, λ_{1/2} and λ_{1/10}, as defined above, are preferably not more than 40 nm apart, particularly preferably not more than 30 nm apart, very particularly preferably not more than 20 nm apart.

In the case of a write-once optical data carrier according to the invention which is written on and read by means of the light of a blue laser, preference is given to merocyanine dyes whose absorption maximum λₘₐₓ₂ is in the range from 420 to 550 nm, where the wavelength λ_{1/2} at which the absorbance in the short wavelength flank of the absorption maximum at the wavelength λₘₐₓ₂ is half of the absorbance value at λₘₐₓ₂ and the wavelength λ_{1/10} at which the absorbance in the short wavelength flank of the absorption maximum at the wavelength λₘₐₓ₂ is one tenth of the absorbance value at λₘₐₓ₂ are preferably not more than 50 nm apart. Such a merocyanine dye preferably has no shorter-wavelength maximum λₘₐₓ₁ down to a wavelength of 350 nm, particularly preferably down to 320 nm, very particularly preferably down to 290 nm.

Preference is given to merocyanine dyes having an absorption maximum λₘₐₓ₂ of from 410 to 530 nm.

Particular preference is given to merocyanine dyes having an absorption maximum λₘₐₓ₂ of from 420 to 510 nm.

Very particular preference is given to merocyanine dyes having an absorption maximum λₘₐₓ₂ of from 430 to 500 nm.

In these merocyanine dyes, λ_{1/2} and λ_{1/10}, as defined above, are preferably not more than 40 nm apart, particularly preferably not more than 30 nm apart, very particularly preferably not more than 20 nm apart.

In the case of a write-once optical data carrier according to the invention which is written on and read by means of the light of a red laser, preference is given to merocyanine dyes whose absorption maximum λₘₐₓ₂ is in the range from 500 to 650 nm, where the wavelength λ_{1/2} at which the absorbance in the long wavelength flank of the absorption maximum at the wavelength λₘₐₓ₂ is half of the absorbance value at λₘₐₓ₂ and the wavelength λ_{1/10} at which the absorbance in the long wavelength flank of the absorption maximum at the wavelength λₘₐₓ₂ is one tenth of the absorbance value at λₘₐₓ₂ are preferably not more than 50 nm apart. Such a merocyanine dye preferably has no longer-wavelength maximum λₘₐₓ₃ up to a wavelength of 750 nm, particularly preferably up to 800 nm, very particularly preferably up to 850 nm.

Preference is given to merocyanine dyes having an absorption maximum λₘₐₓ₂ of from 530 to 630 nm.

Particular preference is given to merocyanine dyes having an absorption maximum λₘₐₓ₂ of from 550 to 620 nm.

Very particular preference is given to merocyanine dyes having an absorption maximum λₘₐₓ₂ of from 580 to 610 nm.

In these merocyanine dyes, λ_{1/2} and λ_{1/10}, as defined above, are preferably not more than 40 nm apart, particularly preferably not more than 30 nm apart, very particularly preferably not more than 20 nm apart.

In the case of a write-once optical data carrier according to the invention which is written on and read by means of the light of a infrared laser, preference is given to merocyanine dyes whose absorption maximum λₘₐₓ₃ is in the range from 650 to 810 nm, where the wavelength λ_{1/2} at which the absorbance in the long wavelength flank of the absorption maximum at the wavelength λₘₐₓ₃ is half of the absorbance value at λₘₐₓ₃ and the wavelength λ_{1/10} at which the absorbance in the long wavelength flank of the absorption maximum at the wavelength λₘₐₓ₃ is one tenth of the absorbance value at λₘₐₓ₃ are preferably not more than 50 nm apart.

Preference is given to merocyanine dyes having an absorption maximum λₘₐₓ₃ of from 660 to 790 nm.

Particular preference is given to merocyanine dyes having an absorption maximum λₘₐₓ₃ of from 670 to 760 nm.

Very particular preference is given to merocyanine dyes having an absorption maximum λₘₐₓ₃ of from 680 to 740 nm.

In these merocyanine dyes, λ_{1/2} and λ_{1/10}, as defined above, are preferably not more than 40 nm apart, particularly preferably not more than 30 nm apart, very particularly preferably not more than 20 nm apart.

The merocyanine dyes have a molar extinction coefficient ε of >40 000 l/mol cm, preferably >60 000 l/mol cm, particularly preferably >80 000 l/mol cm, very particularly preferably >100 000 l/mol cm, at the absorption maximum λ_{max1g}λₘₐₓ₂ and/or λₘₐₓ₃.

The absorption spectra are measured, for example, in solution.

Suitable merocyanines having the required spectral properties are, in particular, those in which the dipole moment change Δμ=|μ_{g}−μ_{ag}|, i.e. the positive difference between the dipole moments in the ground state and in the first excited state, is very small, preferably <5 D, particularly preferably <2 D. A method of determining such a dipole moment change Δμ is described, for example, in F. Würthner et al., Angew. Chem. 1997, 109, 2933, and in the literature cited therein. A low solvent-induced wavelength shift (dioxane/DMF) is likewise a suitable selection criterion. Preference is given to merocyanines whose solvent-induced wavelength shift Δλ=|λ_{DMF}−λ_{dioxane}|, i.e. the positive difference between the absorption wavelengths in the solvents dimethylformamide and dioxane, is <20 nm, particularly preferably <10 nm, very particularly preferably <5 nm

Merocyanines which are very particularly preferred for the purposes of the invention are those of the formulae

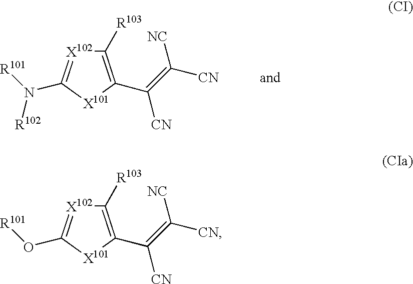

where

X₁₀₁ represents O or S,

X¹⁰² represents Nor CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

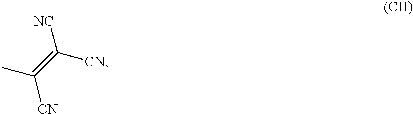

where the alkyl radicals such as propyl, butyl etc., may be branched.

R¹⁰⁴ preferably represents hydrogen or cyano.

Further merocyanines which are very particularly preferred for the purposes of the invention are those of the formulae

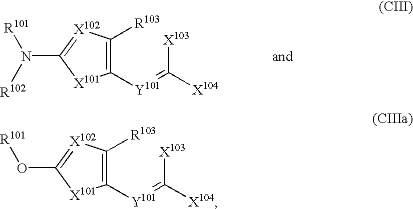

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino, R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or radical of the formula

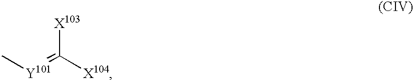

Y¹⁰¹ represents N or CH,

CX¹⁰³X¹⁰⁴ represents a ring of the formula

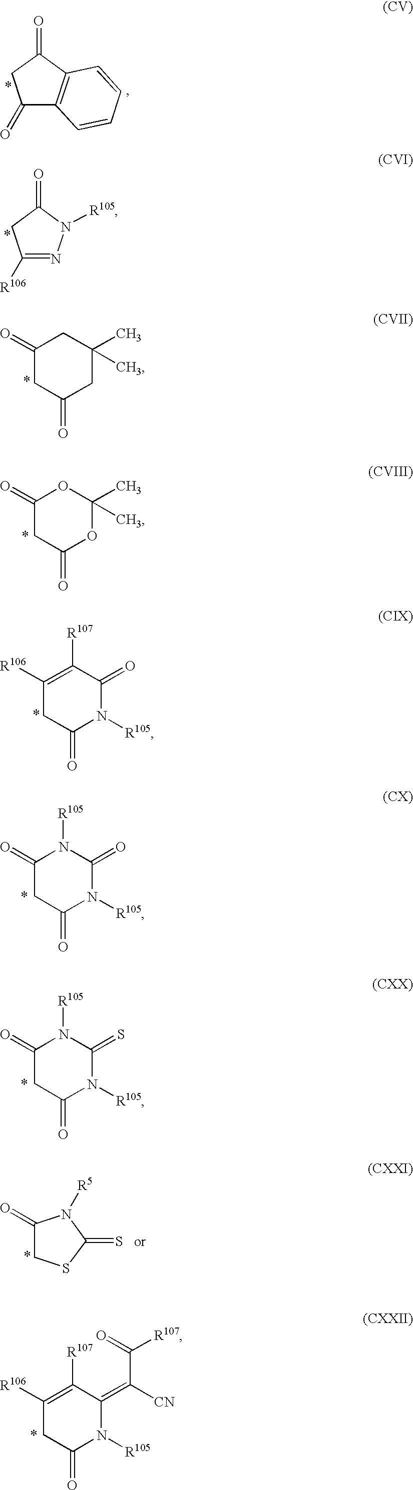

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

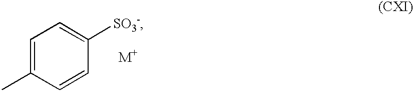

where in the case of the formula (CX), the two radicals R¹⁰⁵ may be different,

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl, —CH₂SO₃⁻M⁺ or a radical of the formula

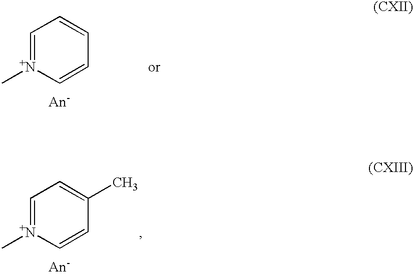

M⁺ represents a cation and

An⁻ represents an anion,

where the alkyl radicals such as propyl, butyl etc., may be branched.

R¹⁰⁴ preferably represents hydrogen or cyano. Y¹ preferably represents CH.

Further merocyanines which are very particularly preferred for the purposes of the invention are those of the formulae

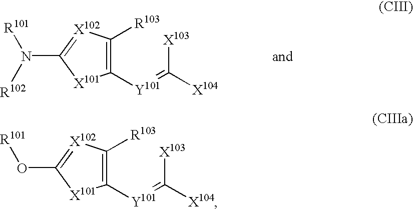

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

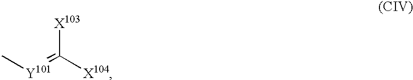

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methylbenzimidazol-2-yl or N-ethylbenzimidazol-2-yl or radical of the formula

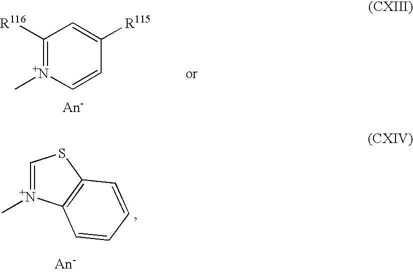

R¹¹⁵ and R¹¹⁶ represent, independently of one another, hydrogen, methyl, cyano or 2- or 4-pyridyl and

An⁻ represents an anion,

where the alkyl radicals such as propyl, butyl etc., may be branched.

R¹⁰⁴ preferably represents hydrogen or cyano. Y¹ preferably represents CH.

CX¹⁰³X¹⁰⁴ preferably represents a radical of the formula

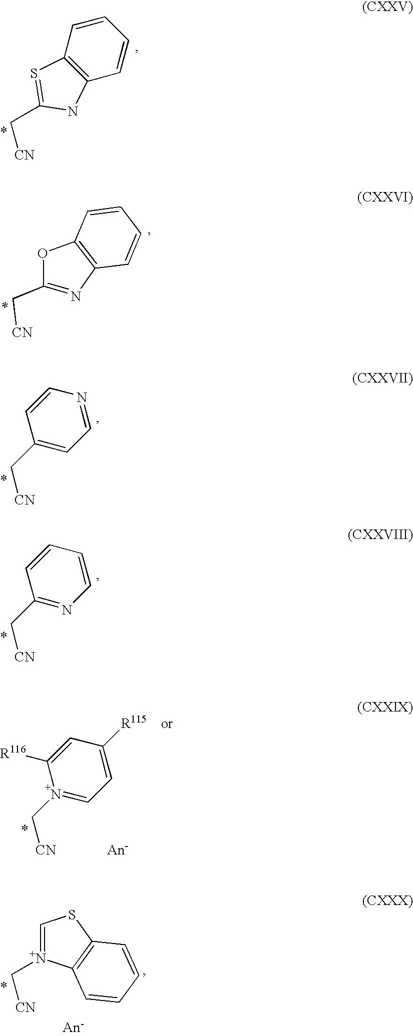

where the asterisk (*) indicates the ring atom from which the double bond extends, and

R¹¹⁵, R¹¹⁶ and An are as defined above.

Further merocyanines which are very particularly preferred for the purposes of the invention are those of the formula

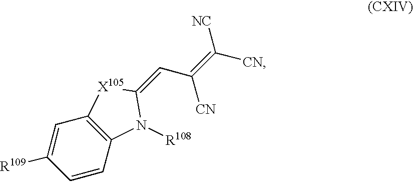

where

X¹⁰⁵ represents S or CR¹¹⁰R¹¹¹,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

R¹¹⁰ and R¹¹¹ represent, independently of one another, methyl or ethyl or

CR¹¹⁰R¹¹¹ represents a bivalent radical of the formula

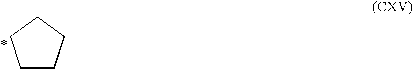

where two bonds go out from the asterisked (*) atom,

where the alkyl radicals such as propyl, butyl etc., may be branched.

X¹⁰⁵ preferably represents C(CH₃)₂.

Further merocyanines which are very particularly preferred for the purposes of the invention are those of the formula

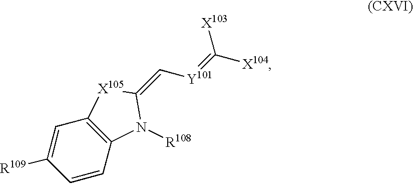

where

X¹⁰⁵ represents S or CR¹¹⁰R¹¹¹,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

R¹¹⁰ and R¹¹¹ represent, independently of one another, methyl or ethyl or

CR¹¹⁰R¹¹¹ represents a bivalent radical of the formula

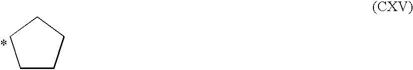

where two bonds go out from the asterisked (*) atom,

Y¹⁰¹ represents N or CH,

CX¹⁰³X¹⁰⁴ represents a ring of the formula

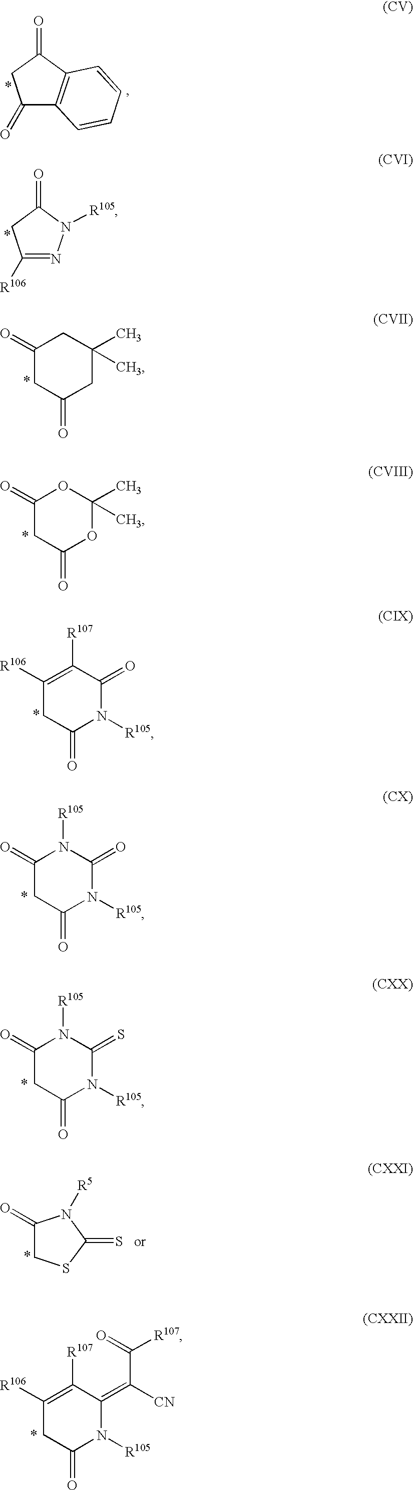

where the asterisk (*) indiates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

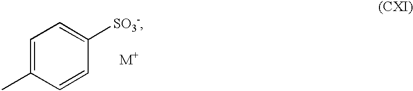

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl, —CH₂SO₃⁻M⁺ or a radical of the formula

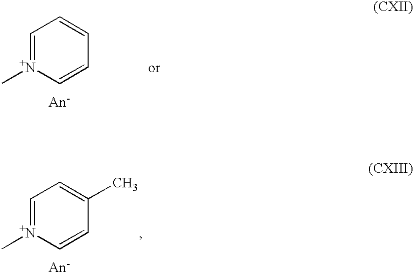

M⁺ represents a cation and

An⁻ represents an anion,

where the alkyl radicals such as propyl, butyl etc., may be branched.

X¹⁰⁵ preferably represents C(CH₃)₂. Y¹ preferably represents CH. CX¹⁰³X¹⁰⁴ preferably represents a radical of the formula (CIX), in which R¹⁰⁷ represents a radical of the formula (CXII) or (CXIII).

Further merocyanines which are very particularly preferred for the purposes of the invention are those of the formula

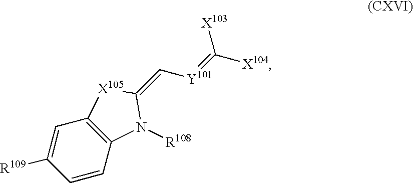

where

X¹⁰⁵ represents S or CR¹¹⁰R¹¹¹,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

R¹¹⁰ and R¹¹¹ represent, independently of one another, methyl or ethyl or

CR¹¹⁰R¹¹¹ represents a bivalent radical of the formula

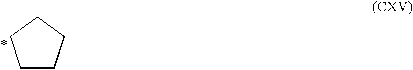

where two bonds go out from the asterisked (*) atom,

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methylbenzimidazol-2-yl- or N-ethyl-benzimidazol-2-yl or a radical of the formula

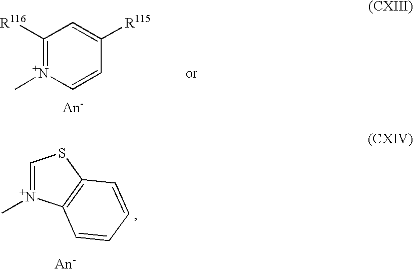

R¹¹⁵ and R¹¹⁶ represent, independently of one another, hydrogen, methyl, cyano or 2- or 4-pyridyl and

An⁻ represents an anion,

where the alkyl radicals such as propyl, butyl etc., may be branched.

X¹⁰⁵ preferably represents C(CH₃)₂. Y¹ preferably represents CH. CX¹⁰³X¹⁰⁴ preferably represents a radical of the formula

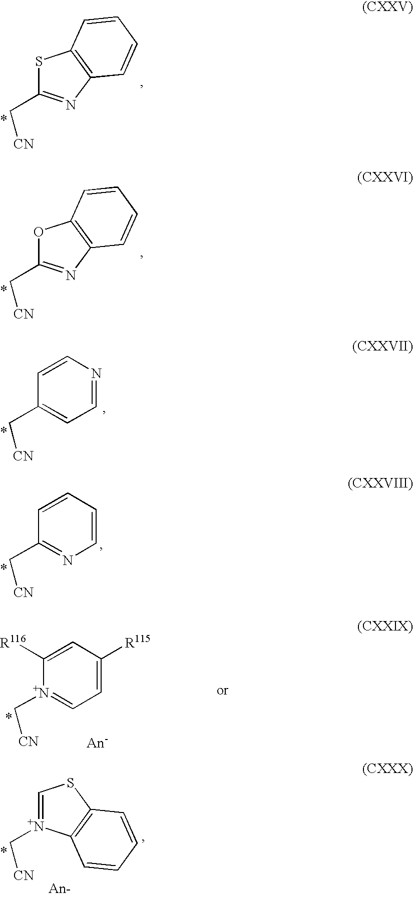

where the asterisk (*) indicates the ring atom from which the double bond extends, and

R¹¹⁵, R¹¹⁶ and An⁻ are as defined above.

CX¹⁰³X¹⁰⁴ particularly preferably represents a radical of one of the formulae (CXXVIII) to (CXXX).

Further merocyanines which are very particularly preferred for the purposes of the invention are those of the formulae

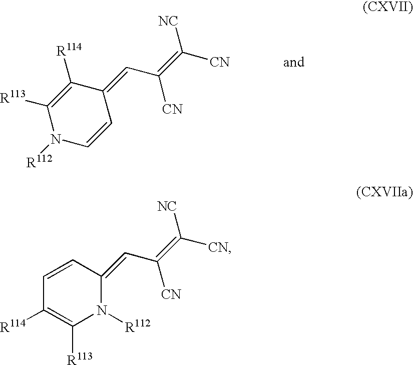

where

R¹¹² represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

where the alkyl radicals such as propyl, butyl etc., may be branched.

Further merocyanines which are very particularly preferred for the purposes of the invention are those of the formulae

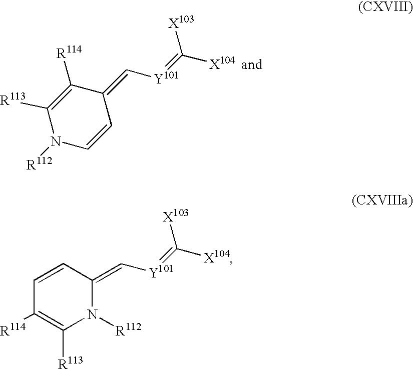

where

R¹¹² represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

Y¹⁰¹ represents Nor CH,

CX¹⁰³X¹⁰⁴ represents a ring of the formula

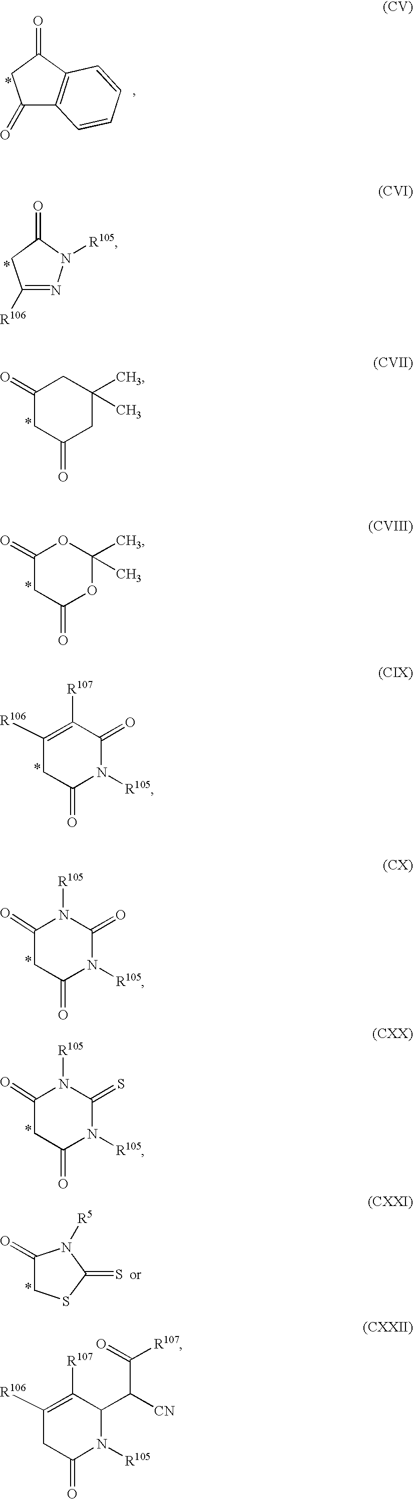

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

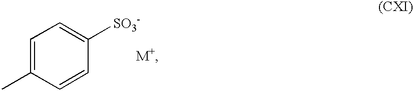

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl, —CH₂SO₃⁻M⁺ or a radical of the formula

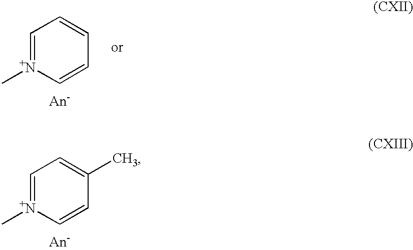

M⁺ represents a cation and

An⁻ represents an anion,

where the alkyl radicals such as propyl, butyl etc., may be branched.

Y¹ preferably represents CH.

Further merocyanines which are very particularly preferred for the purposes of the invention are those of the formulae

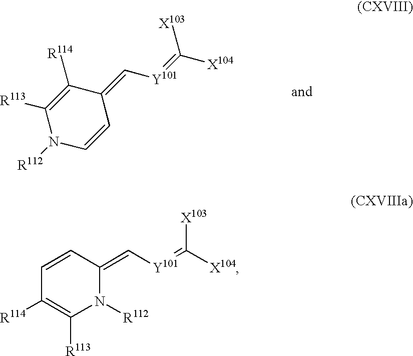

where

R¹¹² represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methylbenzimidazol-2-yl or N-ethyl-benzimidazol-2-yl or a radical of the formula

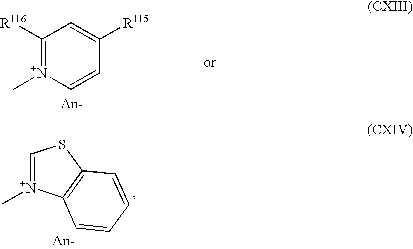

R¹¹⁵ and R¹¹⁶ represent, independently of one another, hydrogen, methyl, cyano or 2- or 4-pyridyl and

An⁻ represents an anion,

where the alkyl radicals such as propyl, butyl, etc., may be branched.

Y¹ preferably represents CH. CX¹⁰³X¹⁰⁴ preferably represents a radical of the formula

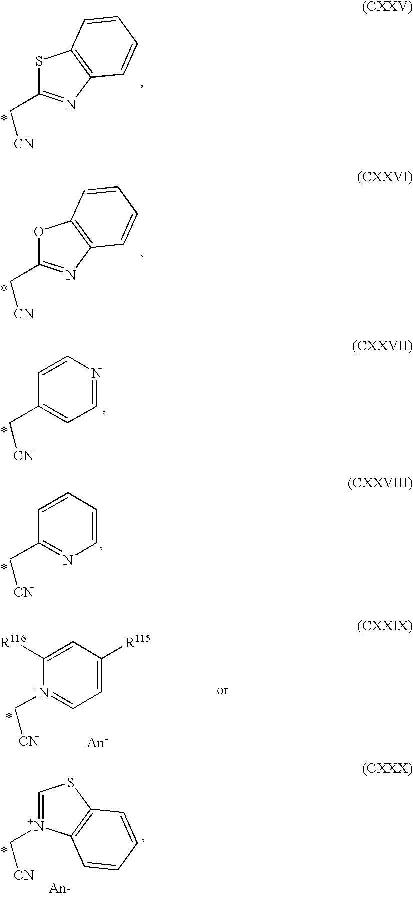

where the asterisk (*) indicates the ring atom from which the double bond extends, and

R¹¹⁵, R¹¹⁶ and An⁻ are as defined above.

Further merocyanines which are very particularly preferred for the purposes of the invention are those of the formula

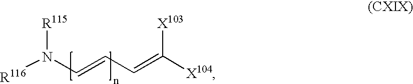

where

R¹¹⁵ and R¹¹⁶ represent, independently of one another, methyl, ethyl, propyl, butyl, pentyl, hexyl, heptyl, octyl, phenyl, benzyl or phenethyl or

NR¹¹⁵R¹¹⁶ represents pyrrolidino, piperidino or morpholino,

CX¹⁰³X¹⁰⁴ represents a ring of the formula

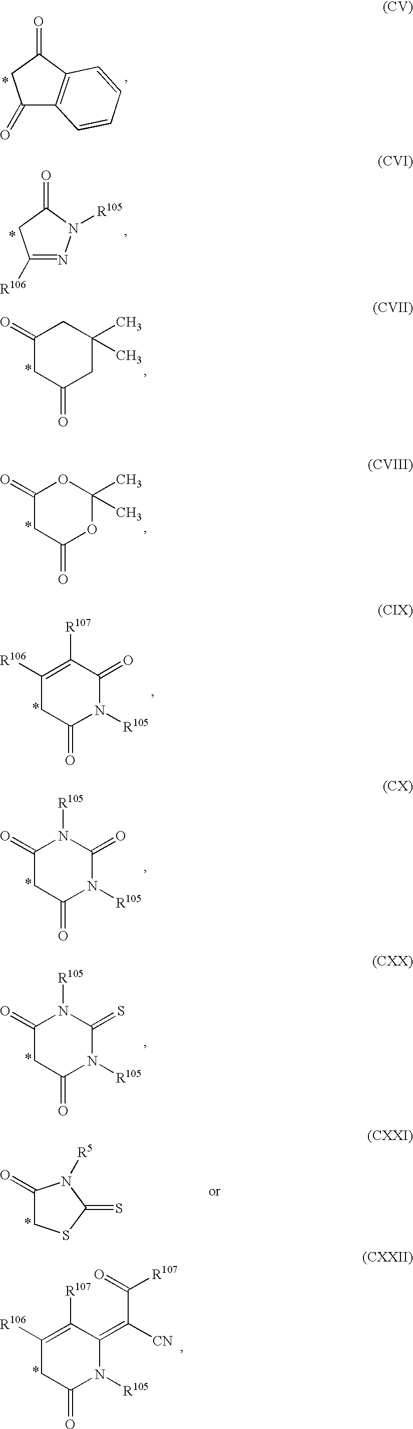

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

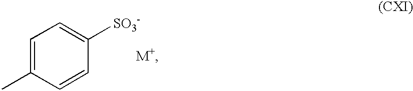

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl, —CH₂SO₃⁻M⁺ or a radical of the formula

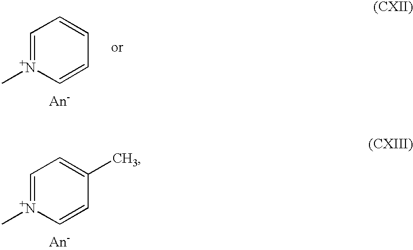

M⁺ represents a cation,

An⁻ represents an anion and

n represents 1 or 2,

where the alkyl radicals such as propyl, butyl, etc., may be branched.

n preferably represents 2. CX¹⁰³X¹⁰⁴ preferably represents a radical of the formula (CIX), where R¹⁰⁷ represents a radical of the formula (CXII) or (CXIII).

Further merocyanines which are very particularly preferred for the purposes of the invention are those of the formula

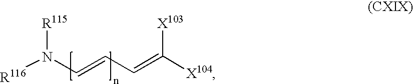

where

R¹¹⁵ and R¹¹⁶ represent, independently of one another, methyl, ethyl, propyl, butyl, pentyl, hexyl, heptyl, octyl, phenyl, benzyl or phenethyl or

NR¹¹⁵R¹¹⁶ represents pyrrolidino, piperidino or morpholino,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methylbenzimidazol-2-yl or N-ethyl-benzimidazol-2-yl or a radial of the formula

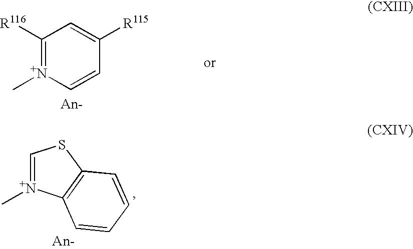

R¹¹⁵ and R¹¹⁶ represent, independently of one another, hydrogen, methyl, cyano or 2- or 4-pyridyl and

An⁻ represents an anion,

where the alkyl radicals such as propyl, butyl, etc., may be branched.

n preferably represents 2. CX¹⁰³X¹⁰⁴ preferably represents a radical of the formula

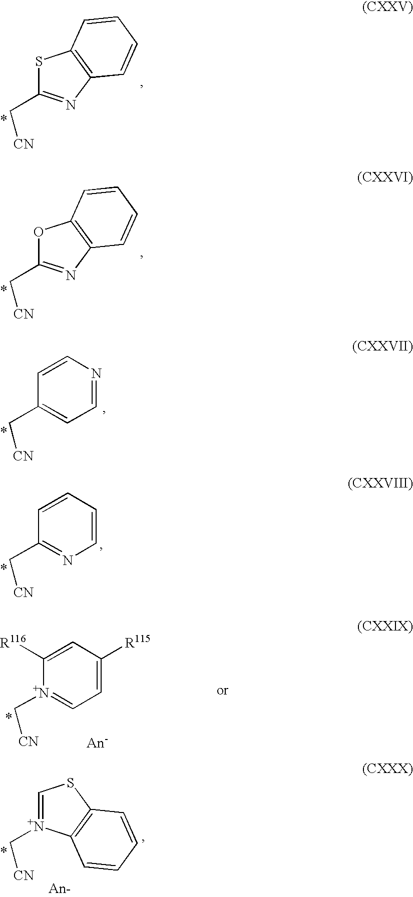

where the asterisk (*) indicates the ring atom from which the double bond extends, and

R¹¹⁵, R¹¹⁶ and An are as defined above.

CX¹⁰³X¹⁰⁴ particularly preferably represents a radical of one of the formulae (CXXVIII) to (CXXX).

Further merocyanines which are very particularly preferred for the purposes of the invention are those of the formula

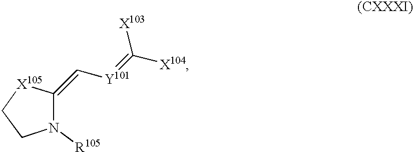

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents N or CH,

CX¹⁰³X¹⁰⁴ represents a ring of the formula

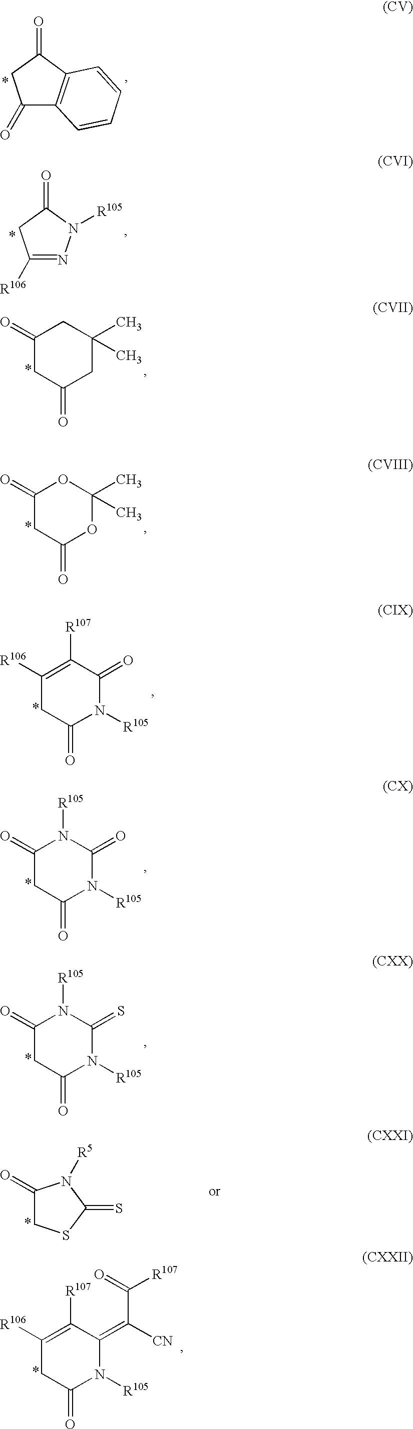

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

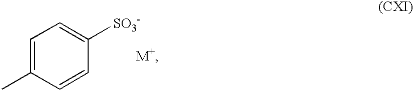

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl, —CH₂SO₃⁻M⁺ or a radical of the formula

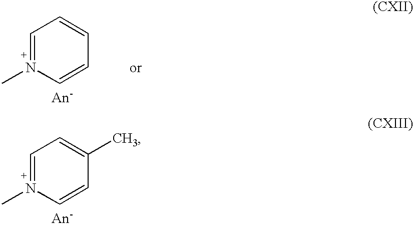

M⁺ represents a cation and

An⁻ represents an anion,

where the alkyl radicals such as propyl, butyl, etc., may be branched.

X¹⁰⁵ preferably represents S or CH₂. Y¹ preferably represents CH. CX¹⁰³X¹⁰⁴ preferably represents a radical of the formula (CIX) in which R¹⁰⁷ represents a radical of the formula (CXII) or (CXIII).

Further merocyanines which are very particularly preferred for the purposes of the invention are those of the formula

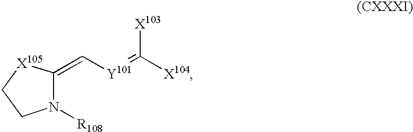

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methylbenzimidazol-2-yl or N-ethylbenzimidazol-2-yl or a radical of the formula

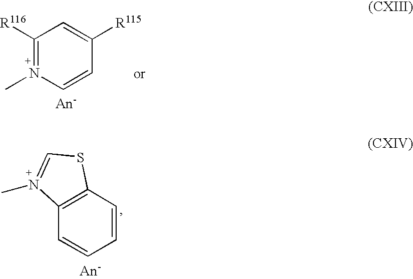

R¹¹⁵ and R¹¹⁶ represent, independently of one another, hydrogen, methyl, cyano or 2- or 4-pyridyl and

An⁻ represents an anion,

where the alkyl radicals such as propyl, butyl etc., may be branched.

X¹⁰⁵ preferably represents S or CH₂. Y¹ preferably represents CH. CX¹⁰³X¹⁰⁴ preferably represents a radical of the formula

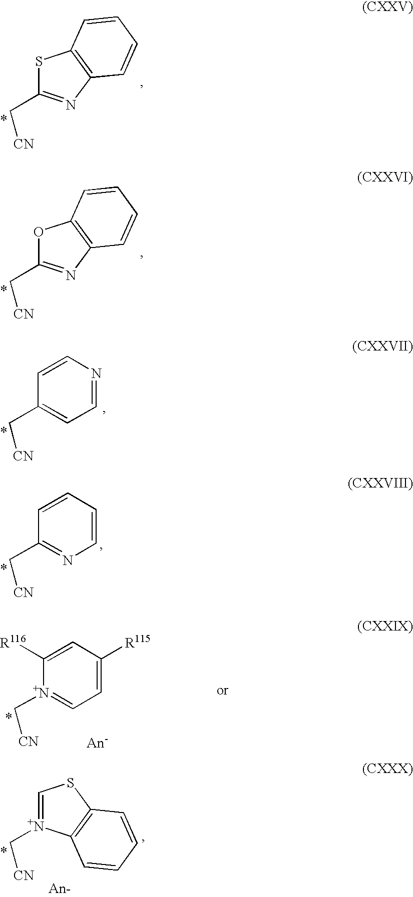

where the asterisk (*) indicates the ring atom from which the double bond extends, and

R¹¹⁵, R¹¹⁶ and An⁻ are as defined above.

CX¹⁰³X¹⁰⁴ particularly preferably represents a radical of one the formulae (CXXVIII) to (CXXX).

In the formulae (CIII), (CXVI), (CXVIII), (CXVIIIa) and (CXXXI),

Y¹⁰¹ preferably represents CH and/oder

in the formulae (CIII), (CIIIa), (CXVI), (CXVIII), (CXVIIIa), (CXIX) and (CXXXI) CX¹⁰³X¹⁰⁴ preferably represents a ring of the formula (CV), (CVII), (CIX) or (CXXII) or a radical of one of the formulae (CXXVIII) to (CXXX).

Some merocyanines of the formula (I) are known, e.g. from F. Würthner, Synthesis 1999, 2103; F. Würthner, R. Sens, K. -H. Etzbach, G. Seybold, Angew. Chem. 1999, 111, 1753; DE-A 43 44 116; DE-A 44 40 066; WO 98/23688; JP 52 99 379; JP 53 14 734.

The invention further provides merocyanines of the formula

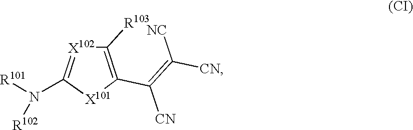

where

X¹⁰¹ represents O or S,

X¹⁰² represents CH,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen,

where the alkyl radicals such as propyl, butyl, etc., may be branched.

The invention likewise provides merocyanines of the formula

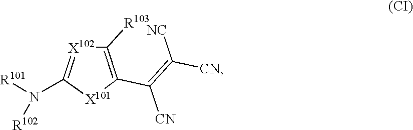

where

X¹⁰¹ represents S,

X¹⁰² represents N,

R¹⁰¹ and R¹⁰² represent, independently of one another, propyl, butyl, pentyl, hexyl, cyclohexyl, benzyl or phenyl and R¹⁰¹ may also be hydrogen or

NR¹⁰¹R¹⁰² represents pyrrolidino or piperidino,

R¹⁰³ represents hydrogen or phenyl,

where the alkyl radicals such as propyl, butyl, etc., may be branched.

The invention likewise provides merocyanines of the formula

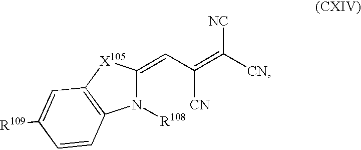

where

X¹⁰⁵ represents C(CH₃)₂,

R¹⁰⁸ represents propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents methyl, ethyl, methoxy, ethoxy, cyano, chlorine, trifluoromethyl, trifluoromethoxy or ethoxycarbonyl,

where the alkyl radicals such as propyl, butyl, etc., may be branched.

The invention likewise provides merocyanines of the formula

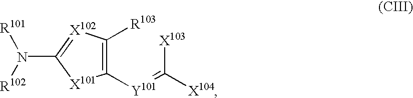

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹¹² represents pyrrolidino, piperidino or morpholino,

R¹⁰³ represents hydrogen or phenyl,

R¹⁰⁴ represents hydrogen or cyano,

Y¹⁰¹ represents CH,

CX¹⁰³X¹⁰⁴ represents a ring of the formula

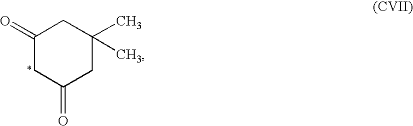

where the asterisk (*) indicates the ring atom from which the double bond extends,

where the alkyl radicals such as propyl, butyl, etc., may be branched.

The invention likewise provides merocyanines of the formula

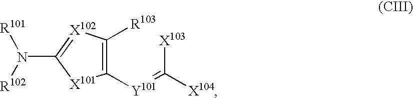

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

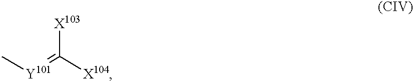

Y¹⁰¹ represents N or CH,

CX¹⁰³X¹⁰⁴ represents a ring of the formula

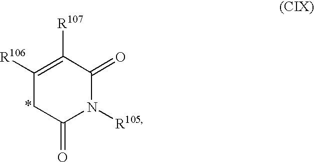

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or a radical of the formula

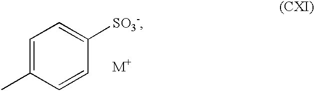

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents —CH₂SO₃⁻M⁺ or a radical of the formula

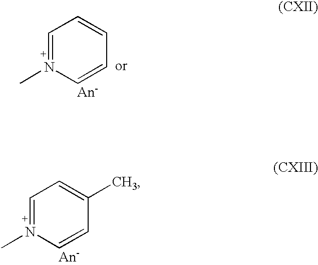

M⁺ represents a cation and

An⁻ represents an anion,

where the alkyl radicals such as propyl, butyl, etc., may be branched.

The invention likewise provides merocyanines of the formula

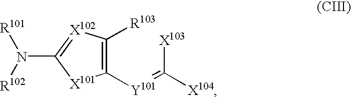

where

X¹⁰¹ represents O or S,

X¹⁰² represents CR¹⁰⁴,

R¹⁰¹ and R¹⁰² represent, independently of one another, methyl, ethyl, propyl, cyclohexyl, benzyl or phenyl and R¹⁰¹ may also be hydrogen or

NR¹⁰¹R¹⁰² represents pyrrolidino or morpholino,

R¹⁰³ represents hydrogen, methyl or ethyl,

R¹⁰⁴ represents hydrogen, methyl or ethyl,

Y¹⁰¹ represents CH,

CX¹⁰³X¹⁰⁴ represents a ring of the formula

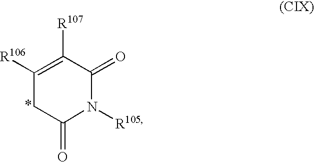

where the asterisk (*) indicates the ring atom from which the double bond extends,

R¹⁰⁵ represents hydrogen, methyl, ethyl, propyl, methoxyethyl, methoxypropyl, cyanoethyl, hydroxyethyl, acetoxyethyl, chloroethyl, cyclohexyl, phenyl, tolyl, methoxyphenyl, —(CH₂)₃—N(CH₃)₂, —(CH₂)₃—N⁺(CH₃)₃ An⁻ or

a radical of the formula

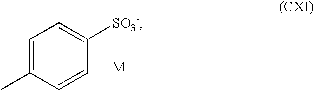

R¹⁰⁶ represents methyl, ethyl, propyl or butyl,

R¹⁰⁷ represents cyano, methoxycarbonyl or ethoxycarbonyl,

M⁺ represents a cation and

An⁻ represents an anion,

where the alkyl radicals such as propyl, butyl, etc., may be branched.

The invention likewise provides merocyanines of the formula

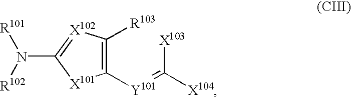

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

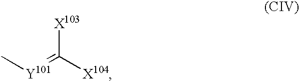

Y¹⁰¹ represents N or CH,

CX¹⁰³X¹⁰⁴ represents a ring of the formula

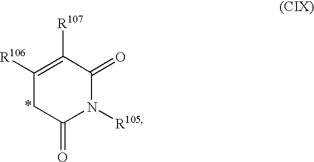

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

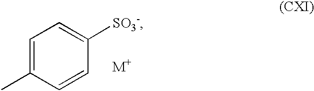

R¹⁰⁶ represents cyano, methoxycarbonyl or ethoxycarbonyl,

R¹⁰⁷ represents cyano, methoxycarbonyl or ethoxycarbonyl,

where the alkyl radicals such as propyl, butyl, etc., may be branched.

The invention likewise provides merocyanines of the formula

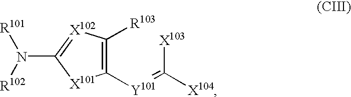

where

X¹⁰¹ represents O or S,

X¹⁰² represents N or CR¹⁰⁴,

R¹⁰¹ and R¹⁰² represent, independently of one another, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen or phenyl,

R¹⁰⁴ represents hydrogen or cyano,

Y¹⁰¹ represents CH,

CX¹⁰³X¹⁰⁴ represents a ring of the formula

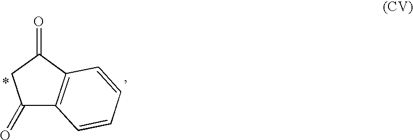

where the asterisk (*) indicates the ring atom from which the double bond extends,

where the alkyl radicals such as propyl, butyl, etc., may be branched.

The invention likewise provides merocyanines of the formula

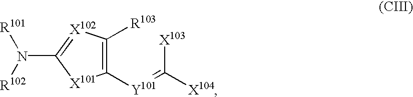

where

X¹⁰¹ represents O or S,

X¹⁰² represents N or CR¹⁰⁴,

R¹⁰¹ and R¹⁰² represent, independently of one another, propyl, butyl, pentyl, hexyl, cyclohexyl, benzyl or phenyl and R¹⁰¹ may also be hydrogen or

NR¹⁰¹ R¹⁰² represents pyrrolidino, piperidino or morpholino,

R¹⁰³ represents hydrogen or phenyl,

R¹⁰⁴ represents hydrogen or cyano,

Y¹⁰¹ represents CH,

CX¹⁰³X¹⁰⁴ represents a ring of the formula

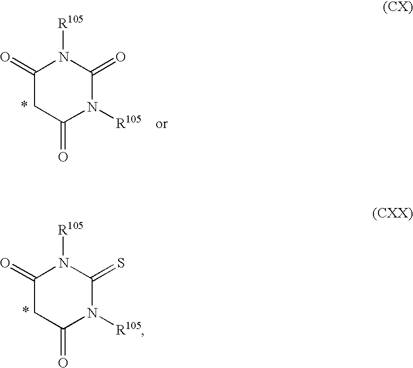

where the asterisk (*) indicates the ring atom from which the double bond extends,

R¹⁰⁵ represents propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl, —(CH₂)₃—N(CH₃)₂, —(CH₂)₃—N⁺(CH₃)₃An⁻ or

a radical of the formula

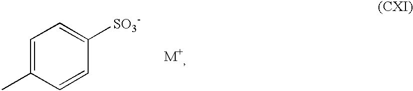

the two radicals R¹⁰⁵ may be different and

M⁺ represents a cation,

An⁻0 represents an anion, where the alkyl radicals such as propyl, butyl, etc., may be branched.

The invention likewise provides merocyanines of the formula

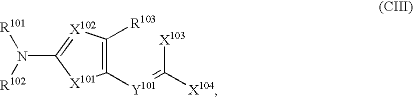

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

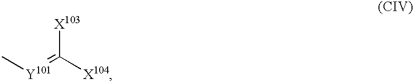

Y¹⁰¹ represents N or CH,

CX¹⁰³X¹⁰⁴ represents a ring of the formula

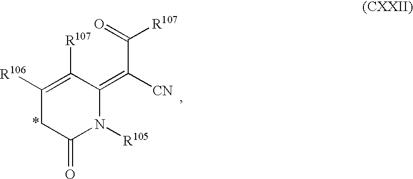

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl or a radical of the formula

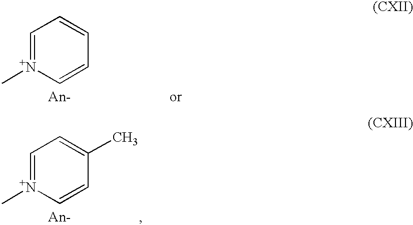

and

An⁻ represents an anion,

where the alkyl radicals such as propyl, butyl, etc., may be branched.

The invention likewise provides merocyanines of the formula

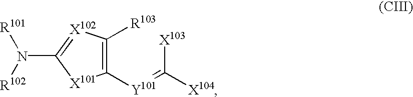

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

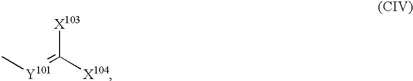

Y¹⁰¹ represents N or CH,

X¹⁰³ represents cyano, methoxycarbonyl or ethoxycarbonyl and

X¹⁰⁴ represents benzothiazol-2-yl, benzoxazol-2-yl or 2- or 4-pyridyl,

where the alkyl radicals such as propyl, butyl, etc., may be branched.

The invention likewise provides merocyanines of the formula

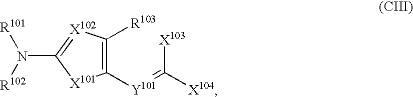

where

X¹⁰¹ represents O or S,

X¹⁰² represents N or CR¹⁰⁴,

R¹⁰¹ and R¹⁰² represent, independently of one another, methyl, ethyl, propyl, butyl, pentyl, hexyl, cyclohexyl, benzyl or phenyl and R¹⁰¹ may also be hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

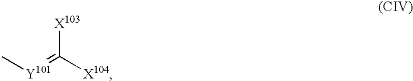

Y¹⁰¹ represents N or CH,

CX¹⁰³X¹⁰⁴ represents a radical of the formula

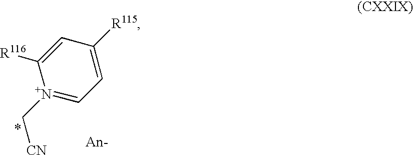

one of the radicals R¹¹⁵ and R¹¹⁶ represents hydrogen, methyl, cyano or 2- or 4-pyridyl and the other represents hydrogen, and

An⁻ represents an anion,

where the alkyl radicals such as propyl, butyl, etc., may be branched.

The invention likewise provides merocyanines of the formula

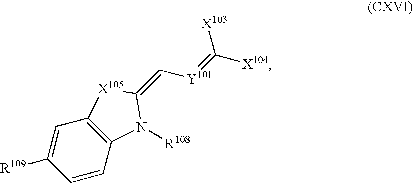

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a ring of the formula

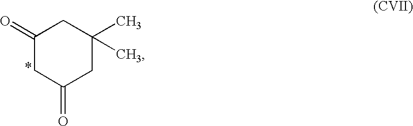

where the asterisk (*) indicates the ring atom from which the double bond extends,

where the alkyl radicals such as propyl, butyl, etc., may be branched.

The invention likewise provides merocyanines of the formula

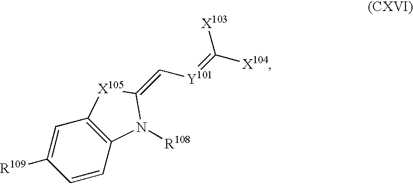

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a ring of the formula

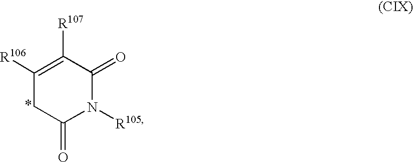

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

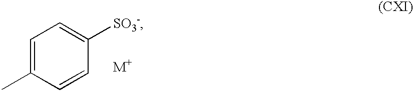

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents —CH₂SO₃⁻M⁺ or a radical of the formula

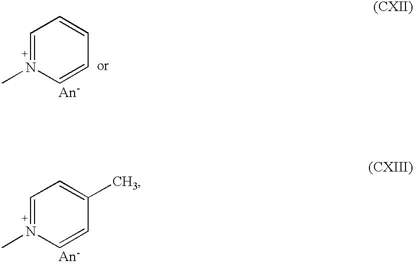

M⁺ represents a cation and

An⁻ represents an anion,

where the alkyl radicals such as propyl, butyl, etc., may be branched.

The invention likewise provides merocyanines of the formula

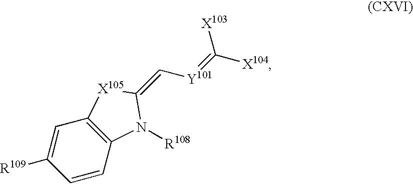

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a ring of the formula

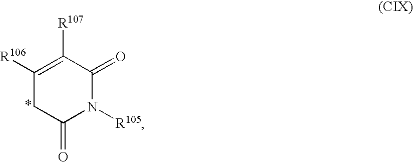

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

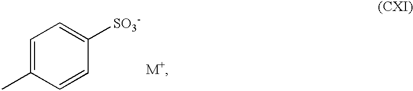

R¹⁰⁶ represents cyano, methoxycarbonyl or ethoxycarbonyl,

R¹⁰⁷ represents cyano, methoxycarbonyl or ethoxycarbonyl,

where the alkyl radicals such as propyl, butyl, etc., may be branched.

The invention likewise provides merocyanines of the formula

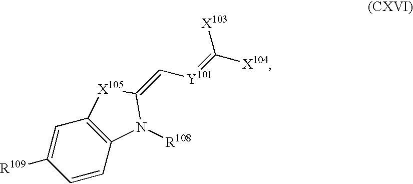

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a ring of the formula

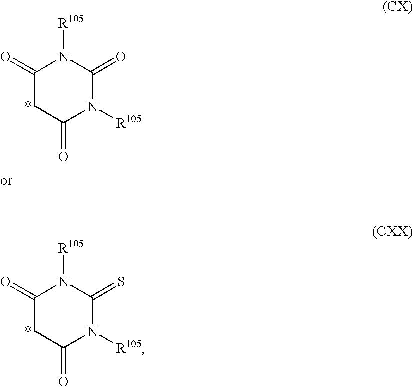

where the asterisk (*) indicates the ring atom from which the double bond extends,

R¹⁰⁵ represents propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl, —(CH₂)₃—N(CH₃)₂, —(CH₂)₃—N⁺(CH₃)₃An⁻ or

a radical of the formula

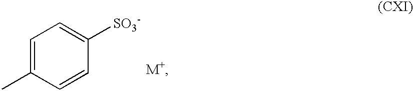

the two radicals R¹⁰⁵ may be different and

M⁺ represents a cation,

An⁻ represents an anion,

where the alkyl radicals such as propyl, butyl, etc., may be branched.

The invention likewise provides merocyanines of the formula

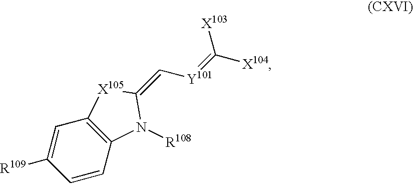

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a ring of the formula

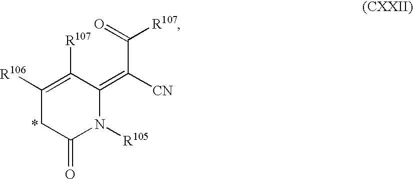

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl or a radical of the formula

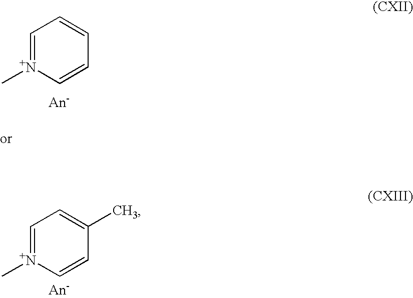

and

An⁻ represents an anion,

where the alkyl radicals such as propyl, butyl, etc., may be branched.

The invention likewise provides merocyanines of the formula

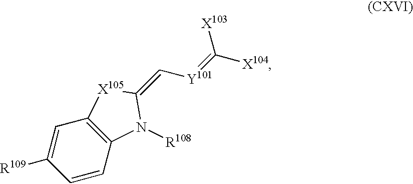

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

X¹⁰³ represents cyano, methoxycarbonyl or ethoxycarbonyl and

X¹⁰⁴ represents benzothiazol-2-yl, benzoxazol-2-yl or 2- or 4-pyridyl, preferably 2-pyridyl,

where the alkyl radicals such as propyl, butyl, etc., may be branched.

The invention likewise provides merocyanines of the formula

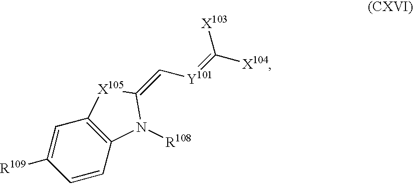

where

X¹⁰⁵ represents C(CH₃)₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, trifluoromethyl, trifluoromethoxy, methoxycarbonyl or ethoxycarbonyl,

Y¹⁰¹ represents CH,

CX¹⁰³X¹⁰⁴ represents a radical of the formula

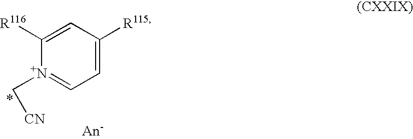

one of the radicals R¹¹⁵ and R¹¹⁶ represents hydrogen, methyl, cyano or 2- or 4-pyridyl and the other represents hydrogen, and

An⁻represents an anion,

where the alkyl radicals such as propyl, butyl, etc., may be branched.

The invention likewise provides merocyanines of the formula

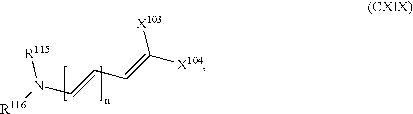

where

R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or

NR¹¹⁵R¹¹⁶ represents pyrrolidino, piperidino or morpholino,

n represents 1 or 2,

CX¹⁰³X¹⁰⁴ represents a ring of the formula

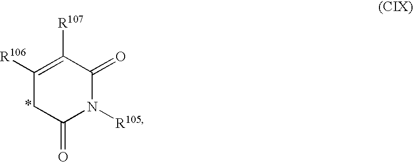

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

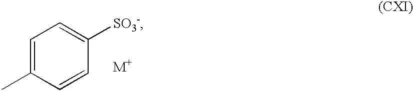

R¹⁰⁶ represents hydrogen, methyl, ethyl, propyl, butyl, trifluoromethyl, cyano, methoxycarbonyl, ethoxycarbonyl, cyclohexyl or phenyl, R¹⁰⁷ represents —CH₂SO₃⁻M⁺or a radical of the formula

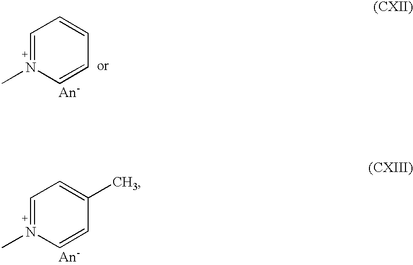

M⁺ represents a cation and

An⁻ represents an anion,

where the alkyl radicals such as propyl, butyl, etc., may be branched.

The invention likewise provides merocyanines of the formula

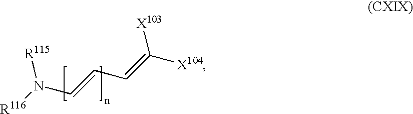

where

R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or

NR¹¹⁵R¹¹⁶ represents pyrrolidino, piperidino or morpholino,

n represents 1 or 2,

CX¹⁰³X¹⁰⁴ represents a ring of the formula

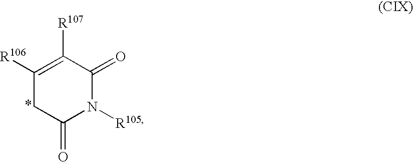

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

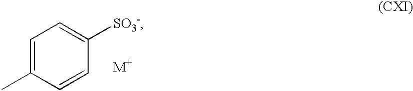

R¹⁰⁶ represents cyano, methoxycarbonyl or ethoxycarbonyl,

R¹⁰⁷ represents cyano, methoxycarbonyl or ethoxycarbonyl,

where the alkyl radicals such as propyl, butyl, etc., may be branched.

The invention likewise provides merocyanines of the formula

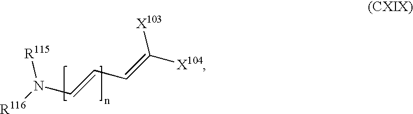

where

R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or

NR¹¹⁵R¹¹⁶ represents pyrrolidino, piperidino or morpholino,

n represents 1 or 2,

CX¹⁰³X¹⁰⁴ represents a ring of the formula

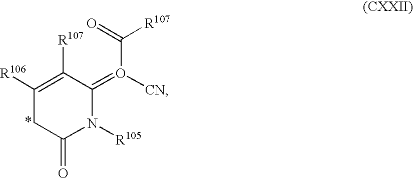

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl or a radical of the formula

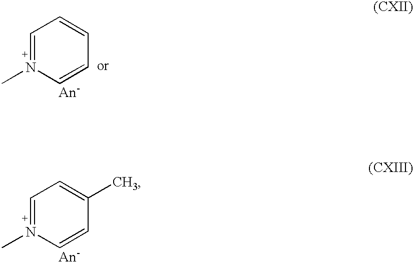

and

An⁻ represents an anion,

where the alkyl radicals such as propyl, butyl, etc., may be branched.

The invention likewise provides merocyanines of the formula

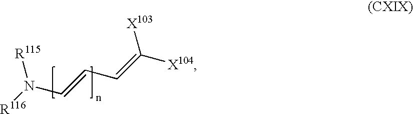

where

R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or

NR¹¹⁵R¹¹⁶ represents pyrrolidino, piperidino or morpholino,

n represents 1 or 2,

X¹⁰³ represents cyano, methoxycarbonyl or ethoxycarbonyl and

X¹⁰⁴ represents benzothiazol-2-yl, benzoxazol-2-yl or 2- or 4-pyridyl, preferably 2-pyridyl,

where the alkyl radicals such as propyl, butyl, etc., may be branched.

The invention likewise provides merocyanines of the formula

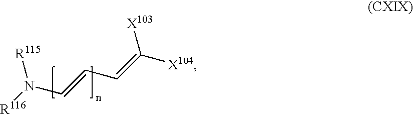

where

R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or

NR¹¹⁵R¹¹⁶ represents pyrrolidino, piperidino or morpholino,

n represents 1 or 2,

CX¹⁰³X¹⁰⁴ represents a radical of the formula

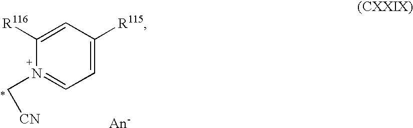

one of the radicals R¹¹⁵ and R¹¹⁶ represents hydrogen, methyl, cyano or 2- or 4-pyridyl and the other represents hydrogen, and

An⁻ represents an anion,

where the alkyl radicals such as propyl, butyl, etc., may be branched.

The invention likewise provides merocyanines of the formula

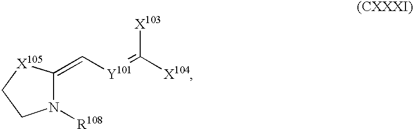

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents CH,

CX¹⁰³X¹⁰⁴ represents a ring of the formula

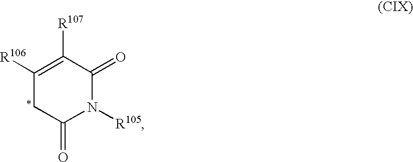

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

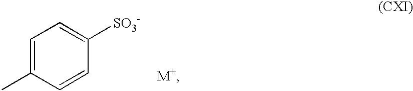

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents —CH₂SO₃⁻ M⁺ or a radical of the formula

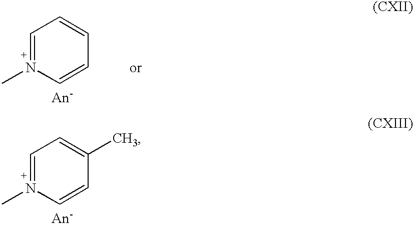

M⁺ represents a cation and

An⁻ represents an anion,

where the alkyl radicals such as propyl, butyl, etc., may be branched.

The invention likewise provides merocyanines of the formula

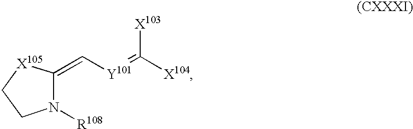

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents CH,

CX¹⁰³X¹⁰⁴ represents a ring of the formula

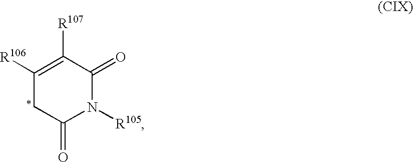

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

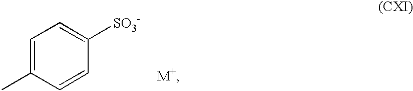

R¹⁰⁶ represents cyano, methoxycarbonyl or ethoxycarbonyl,

R¹⁰⁷ represents cyano, methoxycarbonyl or ethoxycarbonyl,

where the alkyl radicals such as propyl, butyl, etc., may be branched.

The invention likewise provides merocyanines of the formula

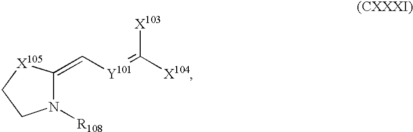

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents CH,

CX¹⁰³X¹⁰⁴ represents a ring of the formula

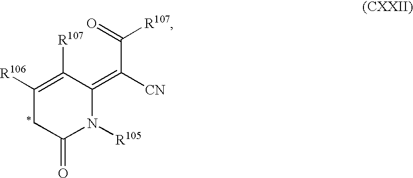

where the asterisk (*) indicates the ring atom from which the double bond extends,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,

R¹⁰⁶ represents hydrogen, methyl, ethyl, propyl, butyl, trifluoromethyl, cyano, methoxycarbonyl, ethoxycarbonyl, cyclohexyl or phenyl,

R¹⁰⁷ represents cyano, methoxycarbonyl, ethoxycarbonyl or a radical of the formula

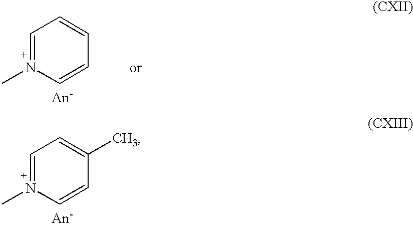

and

An⁻ represents an anion,

where the alkyl radicals such as propyl, butyl, etc., may be branched.

The invention likewise provides merocyanines of the formula

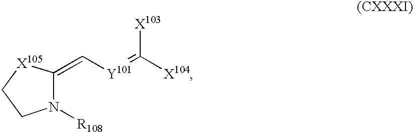

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents CH,

X¹⁰³ represents cyano, methoxycarbonyl or ethoxycarbonyl and

X¹⁰⁴ represents benzothiazol-2-yl, benzoxazol-2-yl or 2- or 4-pyridyl, preferably 2-pyridyl,

where the alkyl radicals such as propyl, butyl, etc., may be branched.

The invention likewise provides merocyanines of the formula

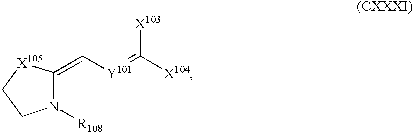

where

X¹⁰⁵ represents O, S or CH₂,

R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,

Y¹⁰¹ represents CH,

CX¹⁰³X¹⁰⁴ represents a radical of the formula

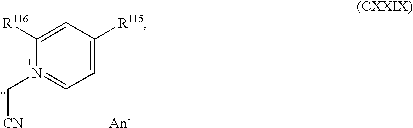

one of the radicals R¹¹⁵ and R¹¹⁶ represents hydrogen, methyl, cyano or 2- or 4-pyridyl and the other represents hydrogen, and

An⁻ represents an anion,

where the alkyl radicals such as propyl, butyl, etc., may be branched.

The light-absorbent compounds described guarantee a sufficiently high reflectivity (>10%) of the optical data carrier in the unwritten state and a sufficiently high absorption for thermal degradation of the information layer on point-wise illumination with focused light if the wavelength of the light is in the range from 360 to 460 nm, from 600 to 680 nm and from 750 to 820 nm. The contrast between written and unwritten points on the data carrier is achieved by the reflectivity change of the amplitude and also the phase of the incident light due to the changed optical properties of the information layer after the thermal degradation.

The merocyanine dyes are preferably applied to the optical data carrier by spin coating or vacuum vapour deposition. The merocyanines can be mixed with one another or with other dyes having similar spectral properties. The information layer can comprise not only the merocyanine dyes but also additives such as binders, wetting agents, stabilizers, diluents and sensitizers and also further constituents.

Apart from the information layer, further layers such as metal layers, dielectric layers and protective layers may be present in the optical data carrier. Metals and dielectric layers serve, inter alia, to adjust the reflectivity and the heat absorption/retention. Metals can be, depending on the laser wavelength, gold, silver, aluminium, etc. Examples of dielectric layers are silicon dioxide and silicon nitride. Protective layers are, for example, photocurable surface coatings, (pressure-sensitive) adhesive layers and protective films.

Pressure-sensitive adhesive layers consist mainly of acrylic adhesives. Nitto Denko DA-8320 or DA-8310, disclosed in the patent JP-A 11-2731471, can, for example, be used for this purpose.

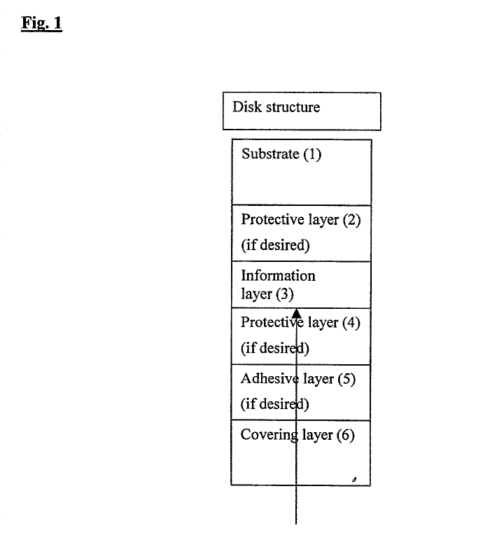

The optical data carrier has, for example, the following layer structure (cf. FIG. 1): a transparent substrate (1), if desired a protective layer (2), an information layer (3), if desired a protective layer (4), if desired an adhesive layer (5), a covering layer(6).

The structure of the optical data carrier preferably:

comprises a preferably transparent substrate (1) to whose surface at least one light-writeable information layer (3) which can be written on by means of light, preferably laser light, if desired a protective layer (4), if desired an adhesive layer (5) and a transparent covering layer (6) have been applied.

comprises a preferably transparent substrate (1) to whose surface a protective layer (2), at least one information layer (3) which can be written on by means of light, preferably laser light, if desired an adhesive layer (5) and a transparent covering layer (6) have been applied.

comprises a preferably transparent substrate (1) to whose surface a protective layer (2) if desired, at least one information layer (3) which can be written on by means of light, preferably laser light, if desired a protective layer (4), if desired an adhesive layer (5) and a transparent covering layer (6) have been applied.

comprises a preferably transparent substrate (1) to whose surface at least one information layer (3) which can be written on by means of light, preferably laser light, if desired an adhesive layer (5) and a transparent covering layer (6) have been applied.

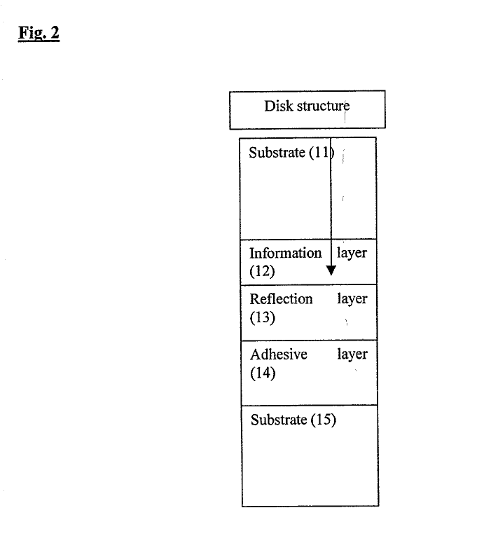

Alternatively, the optical data carrier has, for example, the following layer structure (cf. FIG. 2): a preferably transparent substrate (11), an information layer (12), if desired a reflection layer (13), if desired an adhesive layer (14), a further preferably transparent substrate (15).

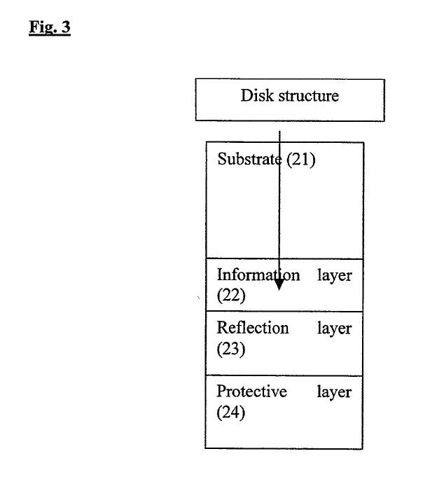

Alternatively, the optical data carrier has, for example, the following layer structure (cf. FIG. 3): a preferably transparent substrate (21), an information layer (22), if desired a reflection layer (23), a protective layer (24).

The invention further provides optical data carriers according to the invention which have been written on by means of blue, red or infrared light, in particular laser light.

The following examples illustrate the subject-matter of the invention.

### EXAMPLES

### Example 1

2.2 g of 1-methyl-3-cyano-4-ethoxycarbonyl-6-hydroxy-2-pyridone and 2.0 g of 1,3,3-trimethylindole-2-methylene-ω-aldehyde were stirred in 5 ml of acetic anhydride at 90° C. for 2 hours. After cooling, the mixture was poured into 100 ml of ice water, filtered with suction and the solid was washed with water. The solid was stirred in 20 ml of water/methanol 3:1, filtered off with suction and dried. This gave 3.0 g (74% of theory) of a blue powder of the formula

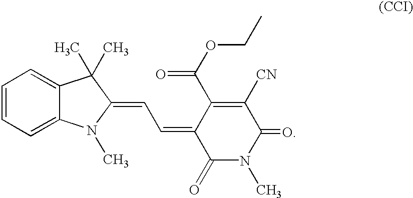

m.p.=183-185° C.

UV (dioxane): λₘₐₓ=587 nm

UV (DMF): λₘₐₓ=609 nm

ε=56010 l/mol cm

Δλ=22 nm

λ_{1/2}-λ_{1/10}(long wavelength flank)=27 nm

Solubility: >2% in TFP (2,2,3,3-tetrafluoropropanol).

### Example 2

An analogous procedure using 1.0 g of dimethylacrolein instead of 1,3,3-trimethylindole-2-methylene-ω-aldehyde gave 1.9 g (63% of theory) of a reddish violet powder of the formula

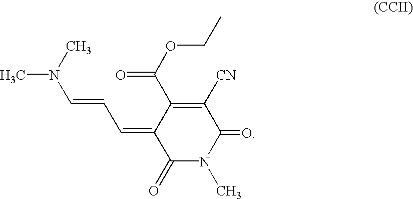

m.p.=160-165° C.

UV (dioxane): λₘₐₓ=542 nm

UV (DMF): λₘₐₓ=567 nm

ε=31630 l/mol cm

Δλ=25 nm

λ_{1/2}-λ_{1/10}(short wavelength flank)=42 nm

Solubility: >2% in TFP.

### Example 3

2.03 g of 3-pyridino-4-methyl-6-hydroxy-pyridone chloride and 2.0 g of 1,3,3-trimethylindole-2-methylene-ω-aldehyde were stirred in 10 ml of acetic anhydride at 90° C. for 2 hours. After cooling, the mixture was poured into 200 ml of water. 2.8 g of sodium tetrafluoroborate were added to the orange solution. After stirring overnight, the mixture was filtered with suction, the solid was washed with 20 ml of water and dried. This gave 3.3 g (74% of theory) of a reddish orange powder of the formula

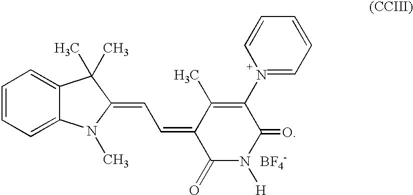

m.p. >300° C.

UV (methanol): λₘₐₓ=513 m

ε=86510 l/mol cm

λ_{1/2}-λ_{1/10}(short wavelength flank)=38 nm

Solubility: >2% in TFP.

### Example 4

0.7 g of 5-dimethylaminofuran-2-carbaldehyde and 1.5 g of N-methyl-N′-dodecyl-barbituric acid were stirred in 15 ml of acetic anhydride at 90° C. for 30 minutes. After cooling, the mixture was poured into 100 ml of ice water, filtered with suction and the solid was washed with water. This gave 1.7 g (79% of theory) of an orange powder of the formula

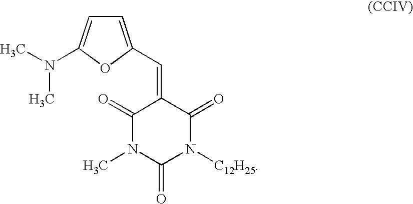

m.p. 118-120° C.

UV (dioxane): λₘₐₓ=483 nm

ε=53360 l/mol cm

λ_{1/2}-λ_{1/10}(short wavelength flank)=32 nm

Solubility: >1% in benzyl alcohol.

Further examples according to the invention are shown in the following tables:

TABLE 1
(formula (VI))

| Ex- ample | 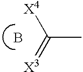 | Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 5 | 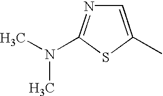 | C—CN | ═C(CN)₂ | 470 | 40990 | 32³⁾ | 16 |
| 6 | ″ | CH | 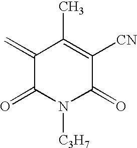 | 502 | 62860 | 33³⁾ | |
| 7 | 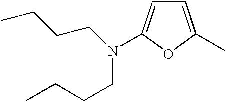 | CH | ″ | 539 | 146480 | 18⁴⁾ | 1.5 |
| 8 | ″ | CH | 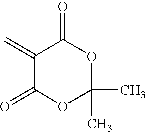 | 472 | 70880 | 32³⁾ | 5 |
| 9 | ″ | CH | 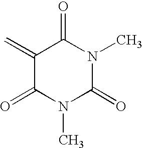 | 490⁶⁾ | 117700 | | |
| 10 | ″ | CH | 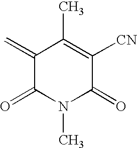 | 539 | 106640 | | |
| 11 | 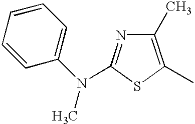 | CH | 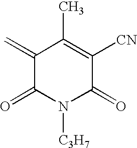 | | | | |
| 12 | 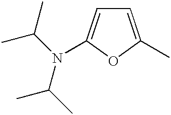 | CH | 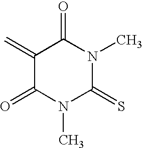 | | | | |
| 13 | 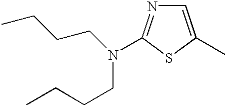 | CH | 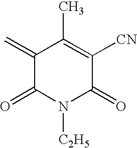 | 508 | 78400 | | |
| 14 | 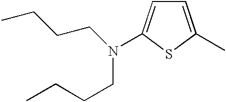 | CH | 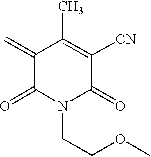 | 535 | 112260 | 13⁴⁾ | |
| 15 | 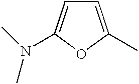 | CH | 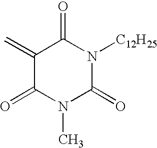 | 483 | 53360 | | |
| 16 | ″ | CH | 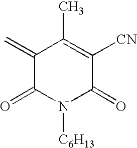 | 535 | 128960 | | 1.3 |
| 17 | 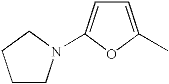 | CH | 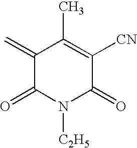 | 536⁶⁾ | 115603 | | 2 |
| 18 | 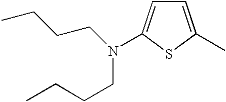 | CH | 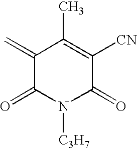 | 535 | 112260 | 13⁴⁾ | |
| 19 | 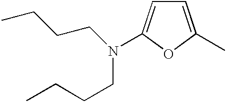 | CH | 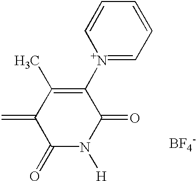 | | | | |
| 20 | ″ | CH | 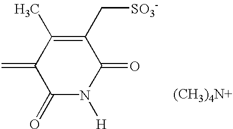 | | | | |
| 21 | 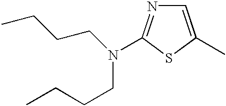 | N | 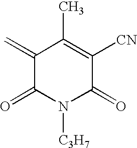 | | | | |
| 22 | ″ | C—CN | ═C(CN)₂ | | | | |
| 23 | 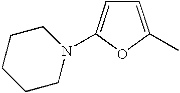 | CH | 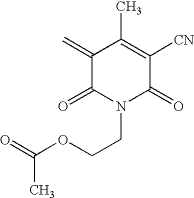 | | | | |
| 24 | 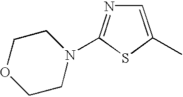 | CH | 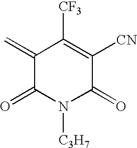 | | | | |
| 25 | 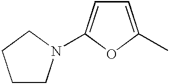 | CH | 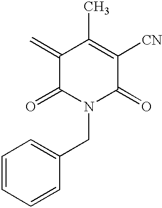 | | | | |
| 26 | 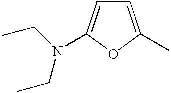 | CH | 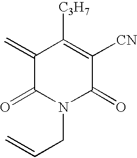 | | | | |
| 27 | 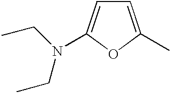 | CH | 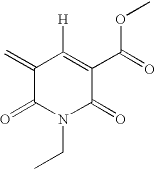 | | | | |
| 28 | 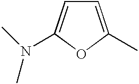 | CH | 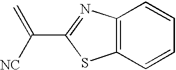 | 490 | 35000 | 40³⁾ | 23 |
| 29 | 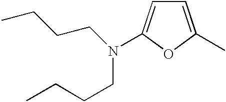 | CH | 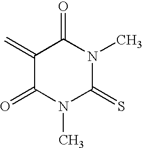 | 508 | 153420 | 11⁴⁾ | |
| 30 | 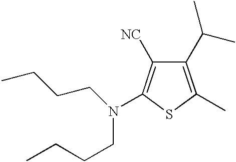 | CH | 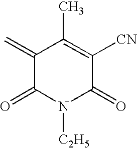 | 537 | 85995 | 16⁵⁾ | |
| 31 | ″ | CH | 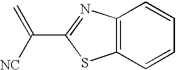 | 469 | 46735 | | |
| 32 | 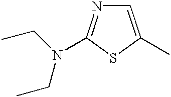 | CH | 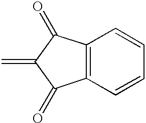 | 472 | 62026 | 42³⁾ | |
| 33 | ″ | CH | 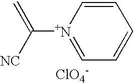 | 432⁵⁾ | 28360 | | |
| 34 | 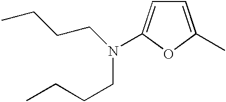 | CH | 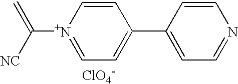 | | | | |
| 35 | 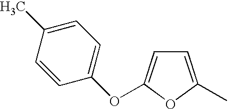 | CH | 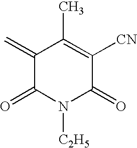 | | | | |
| 36 | 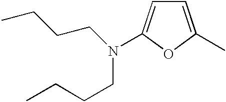 | CH | 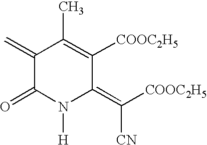 | | | | |

¹⁾in dioxane unless indicated otherwise
²⁾= |λ_{DMF}-λ_{-dioxane}|
³⁾on the short wavelength flank
⁴⁾on the long wavelength flank
⁵⁾in methanol
⁶⁾in DMF

TABLE 2
(formula (VII))

| Ex- ample | 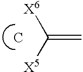 | Y²-Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 37 | 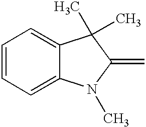 | CH—C(CN) | ═C(CN)₂ | 499 | 46470 | 36³⁾ | 5 |
| 38 | ″ | CH—CH | 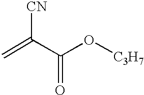 | 429 | 60390 | 30³⁾ | 7 |
| 39 | ″ | CH—CH | 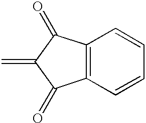 | 487 | 102220 | 35³⁾ | 6 |
| 40 | ″ | CH—CH | 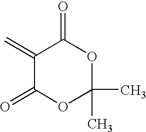 | 448 | 76260 | 27³⁾ | 2 |
| 41 | ″ | CH—CH | 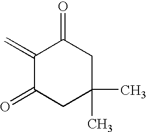 | 469 | 76130 | 28³⁾ | 3 |
| 42 | ″ | CH—CH | 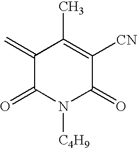 | 520 | 113100 | 12⁴⁾ | 2 |
| 43 | 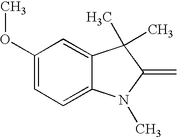 | CH—C(CN) | ═C(CN)₂ | 511 | 31345 | 36³⁾ | 6 |
| 44 | 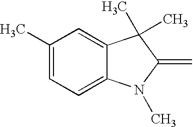 | CH—C(CN) | ″ | 503 | 41530 | 36³⁾ | 6 |
| 45 | 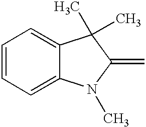 | CH—CH | 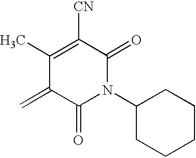 | 519 | 55910 | 11⁴⁾ | |
| 46 | 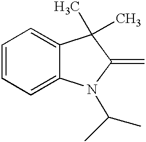 | CH—CH | 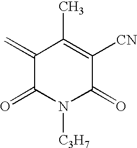 | | | | |
| 47 | ″ | CH—CH | 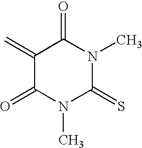 | | | | |
| 48 | 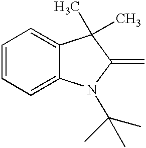 | CH—CH | 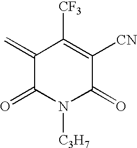 | | | | |
| 49 | 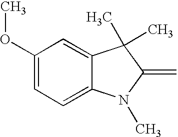 | CH—CH | 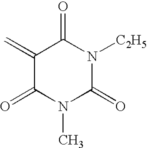 | | | | |
| 50 | ″ | CH—CH | 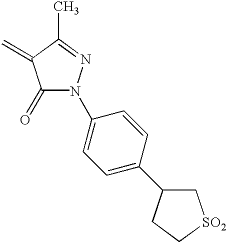 | 473 | 47640 | | |
| 51 | 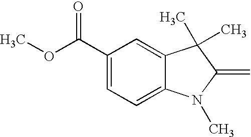 | CH—CH | 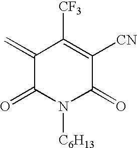 | | | | |
| 52 | ″ | CH—CH | 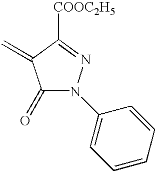 | 496 | 62720 | | |
| 53 | ″ | CH—CH | 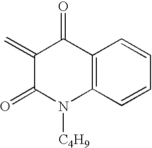 | 500 | 110332 | | |
| 54 | 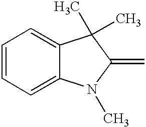 | CH—CH | 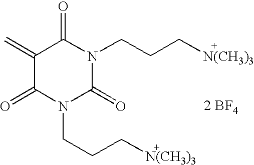 | | | | |
| 55 | 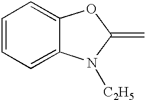 | CH—CH | 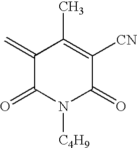 | 490⁶⁾ | 109380 | | 5 |
| 56 | 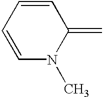 | CH—CH | 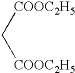 | 450 | | | |
| 57 | 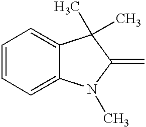 | CH—CH | 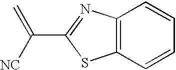 | 462 | 57230 | 34³⁾ | |
| 58 | 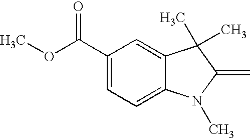 | CH—CH | 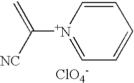 | 459⁵⁾ | 36010 | | |
| 59 | 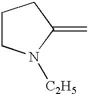 | CH—CH | ″ | 462⁵⁾ | 24400 | | |
| 60 | ″ | CH—CH | 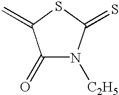 | 466 | 75006 | 10⁴⁾ | |
| 61 | 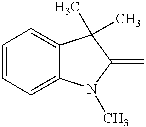 | CH—CH | ″ | 512⁶⁾ | 36610 | 25⁴⁾ | 36⁷⁾ |
| 62 | 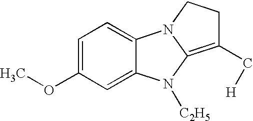 | | ═C(CN)₂ | | | | |
| 63 | 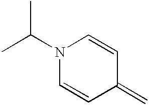 | CH—CH | 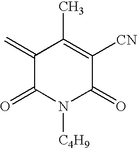 | 514⁸⁾ | 63510 | 40³⁾ | |
| 64 | 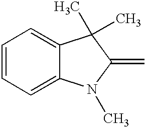 | CH—CH | 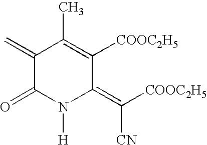 | 577⁵⁾ | | | |
| 65 | 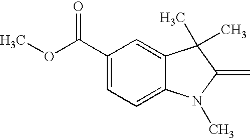 | CH—CH | ″ | 587⁵⁾ | 142900 | | |
| 66 | 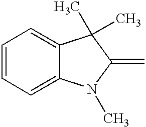 | CH—CH | 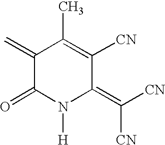 | 546⁵⁾ | | | |
| 67 | 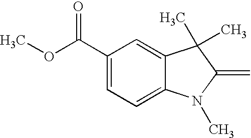 | CH—CH | ″ | 554⁵⁾ | 50900 | | |

¹⁾in dioxane unless indicated otherwise
²⁾= |λ_{DMF} - λ_{dioxane}|
³⁾on the short wavelength flank
⁴⁾on the long wavelength flank
⁵⁾in methanol
⁶⁾in methylene chloride
⁷⁾= |λ_{methylene chloride}-λₘₑₜₕₐₙₒₗ|
⁸⁾in DMF

TABLE 3
(formula (VIII))

| Ex- ample | 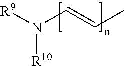 | Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 68 | 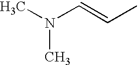 | CH | 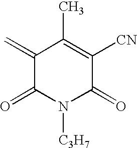 | 462 | 77180 | 28³⁾ | 8 |
| 69 | ″ | CH | 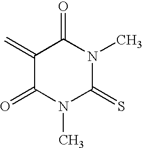 | | | | |
| 70 | ″ | CH | 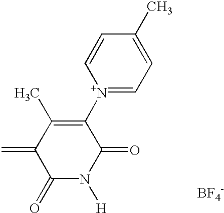 | 446⁵⁾ | | | |
| 71 | ″ | CH | 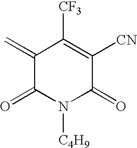 | 564⁶⁾ | 89100 | | |
| 72 | 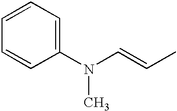 | CH | 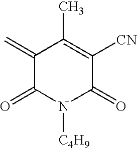 | 480 | 79685 | | 1.3 |
| 73 | ″ | CH | 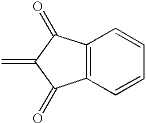 | 447 | 84070 | | |
| 74 | 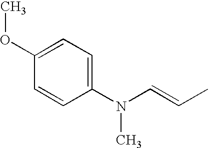 | CH | 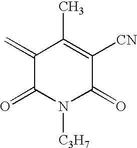 | 482 | 73010 | | 4.3 |
| 75 | ″ | CH | 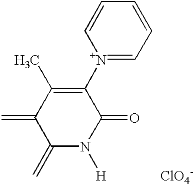 | 469⁵⁾ | 62780 | | |
| 76 | 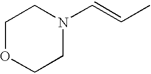 | CH | 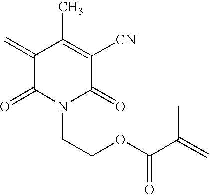 | 458 | 89800 | 28³⁾ | |
| 77 | ″ | CH | 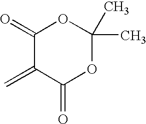 | 390⁶⁾ | 80200 | 11⁴⁾ | |
| 78 | ″ | CH | 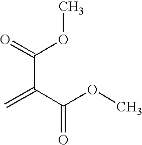 | 366 | | | |
| 79 | ″ | CH | 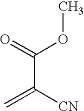 | 382 | 62900 | | |
| 80 | 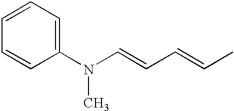 | CH | 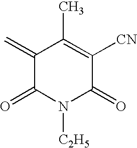 | 585 | 119800 | 28⁴⁾ | |
| 81 | ″ | CH | 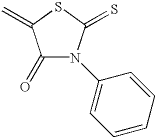 | | | | |
| 82 | 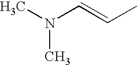 | CH | ″ | 452 | 61685 | | |
| 83 | 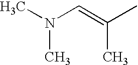 | CH | 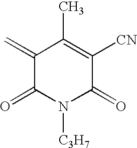 | 337 | | | |
| 84 | 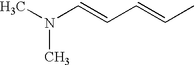 | CH | 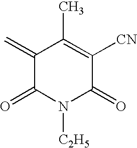 | 552⁶⁾ | 149800 | | |
| 85 | 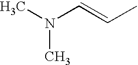 | CH | 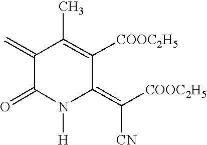 | 509⁵⁾ | | | |

¹⁾in dioxane unless indicated otherwise
²⁾= |λ_{DMF}-λ_{dioxane}|
³⁾on the short wavelength flank
⁴⁾on the long wavelength flank
⁵⁾in methanol
⁶⁾in DMF

### Example 86

A 4% strength by weight solution of the dye from Example 7 in 2,2,3,3-tetrafluoropropanol was prepared at room temperature. This solution was applied by means of spin coating to a pregrooved polycarbonate substrate. The pregrooved polycarbonate substrate had been produced as a disk by means of injection moulding. The dimensions of the disk and the groove structure corresponded to those customarily used for DVD-Rs. The disk with the dye layer as information carrier was coated with 100 nm of silver by vapour deposition. A UV-curable acrylic coating composition was subsequently applied by spin coating and cured by means of a UV lamp. The disk was tested by means of a dynamic writing test apparatus constructed on an optical tester bench comprising a diode laser (λ=405 nm) for generating linearly polarized light, a polarization-sensitive beam splitter, a λ/4 plate and a movably suspended collecting lens having a numerical aperture NA=0.65 (actuator lens). The light reflected from the reflection layer of the disk was taken out from the beam path by means of the abovementioned polarization-sensitive beam splitter and focused by means of an astigmatic lens onto a four-quadrant detector. At a linear velocity V=5.2 m/s and a writing power P_{w}=13.2 mW, a signal-noise ratio C/N=48 dB was measured. The writing power was applied as an oscillating pulse sequence, with the disk being irradiated alternately for 1 μs with the above-mentioned writing power P_{w} and for 4 μs with the reading power Pᵣ≈0.44 mW. The disk was irradiated with this oscillating pulse sequence until it had rotated once. The marking produced in this way was then read using the reading power Pᵣ≈0.44 mW and the abovementioned signal/noise ratio C/N was measured.

### Example 87

A procedure analogous to that of Example 86 was used to produce and measure a disk with the dye from Example 2. At a writing power P_{w}=13.2 mW and a linear velocity V=2.6 m/s, C/N=45 dB was obtained.

### Example 88

A disk with the dye from Example 65 which had been produced using a method analogous to Example 86 was measured in a test apparatus which was similar to that in Example 86 but differed in the diode laser (λ=656 nm) and the actuator lens (NA=0.60). At a writing power P_{w}=24 mW and a linear velocity V=3.5 m/s, C/N=39.5 dB was obtained.

1. Optical data carrier comprising a preferably transparent substrate which may, if desired, have previously been coated with one or more reflection layers and to whose surface a light-writeable information layer, if desired one or more reflection layers and if desired a protective layer or a further substrate or a covering layer have been applied, which can be written on or read by means of blue, red or infrared light, preferably laser light, where the information layer comprises a light-absorbent compound and, if desired, a binder, characterized in that at least one merocyanine dye is used as light-absorbent compound.

2. Optical data carrier according to claim 1, characterized in that the merocyanine dye has the formula 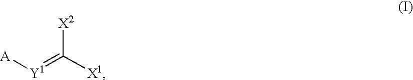
where
A represents a radical of the formula 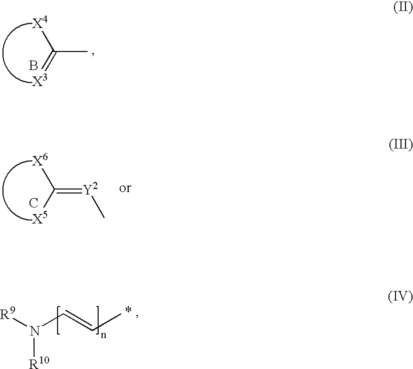
X¹ represents CN, CO—R¹, COO—R², CONHR³, CONR³R⁴ or SO₂R¹,
X² represents hydrogen, C₁-C₆-alkyl, C₆-C₁₀-aryl, a five- or six-membered heterocyclic radical, CN, CO—R¹, COO—R², CONHR³, CONR³R⁴; SO₂R¹ or a radical of the formula 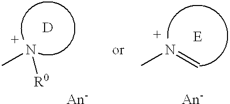
or
CX¹X² represents a ring of the formula 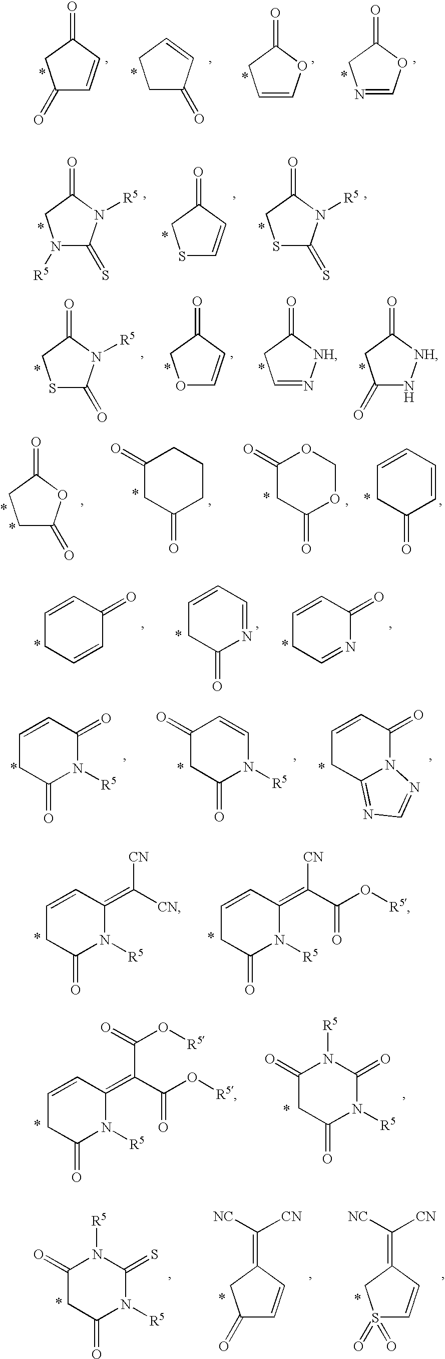
which may be benzo- or naphtho-fused and/or substituted by nonionic or ionic radicals, where the asterisk (*) indicates the ring atom from which the double bond extends,
X³ represents N or CH,
X⁴ represents O, S, N, N—R⁶ or CH, where X³ and X⁴ do not simultaneously represent CH,
X⁵ represents O, S or N—R⁶,
X⁶ represents O, S, N, N—R⁶, CH or CH₂,
the ring B of the formula (II) 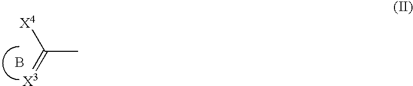
together with X⁴, X³ and the C atom between them
and the ring C of the formula (V) 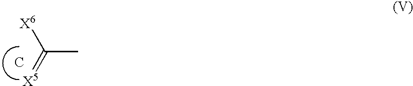
together with X⁵, X⁶ and the C atom between them
each represent, independently of one another, a five- or six-membered aromatic, pseudoaromatic or partially hydrogenated heterocyclic ring which can contain from 1 to 4 heteroatoms and/or may be benzo- or naphtho-fused and/or substituted by nonionic or ionic radicals,
the ring D together with the N atom represents a hydrogenated five- or six-membered heterocyclic ring which can contain from 1 to 4 heteroatoms and/or may be substituted by nonionic or ionic radicals,
the ring E together with the N atom represents an aromatic, pseudoaromatic or partially hydrogenated five- or six-membered heterocyclic ring which can contain from 1 to 4 heteroatoms and/or may be benzo- or naphtho-fused and/or substituted by nonionic or ionic radicals,
An⁻ represents an anion,
Y¹ represents N or C—R⁷,
Y² represents N or C—R⁸,
R⁰ represents C₁-C₆-alkyl or C₇-C₁₅-aralkyl,
R¹ to R⁶ and R^{5′} represent, independently of one another, hydrogen, C₁-C₆-alkyl, C₃-C₆-alkenyl, C₅-C₇-cycloalkyl, C₆-C₁₀-aryl or C₇-C₁₅-aralkyl,
R⁷ and R⁸ represent, independently of one another, hydrogen, cyano or C₁-C₆-alkyl or
R⁶ and R⁸ together represent a —(CH₂)₂— or (CH₂)₃— bridge,
R⁹ and R¹⁰ represent, independently of one another, C₁-C₆-alkyl, C₆-C₁₀-aryl, a five- or six-membered heterocyclic radical or C₇-C₁₅-aralkyl or
NR⁹R¹⁰ may form a five- or six-membered ring and
n represents 1 or 2.

3. Optical data carrier according to claim 2, characterized in that
the ring B of the formula (II) represents furan-2-yl, thiophen-2-yl, pyrrol-2-yl, benzofuran-2-yl, benzothiophen-2-yl, thiazol-5-yl, imidazol-5-yl, 1,3,4-thiadiazol-2-yl, 1,3,4-triazol-2-yl, 2- or 4-pyridyl, 2- or 4-quinolyl, where the individual rings may be substituted by C₁-C₆-alkyl, C₁-C₆-alkoxy, fluorine, chlorine, bromine, iodine, cyano, nitro, C₁-C₆-alkoxycarbonyl, C₁-C₆-alkylthio, C₁-C₆-acylamino, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino or piperidino, and
the ring C of the formula (V) represents benzothiazol-2-ylidene, benzoxazol-2-ylidene, benzimidazol-2-ylidene, pyrrolin-2-ylidene, thiazol-2-ylidene, thiazolin-2-ylidene, isothiazol-3-ylidene, isoxazol-3-ylidene, oxazolin-2-ylidene, imidazol-2-ylidene, pyrazol-5-ylidene, 1,3,4-thiadiazol-2-ylidene, 1,3,4-oxadiazol-2-ylidene, 1,2,4-thiadiazol-5-ylidene, 1,3,4-triazol-2-ylidene, 3H-indol-2-ylidene, dihydropyridin-2- or -4-ylidene, dihydroquinolin-2- or -4-ylidene, where the individual rings may be substituted by C₁-C₆-alkyl, C₁-C₆-alkoxy, fluorine, chlorine, bromine, iodine, cyano, nitro, C₁-C₆-alkoxycarbonyl, C₁-C₆-alkylthio, C₁-C₆-acylamino, C₆-C₁₀-aryl, C₆-C₁₀-aryloxy, C₆-C₁₀-arylcarbonylamino, mono- or di-C₁-C₆-alkylamino, N—C₁-C₆-alkyl-N—C₆-C₁₀-arylamino, pyrrolidino, morpholino or piperidino.

4. Optical data carrier according to one or more of claims 1 to 3, characterized in that the merocyanine dye has the formula (VI) 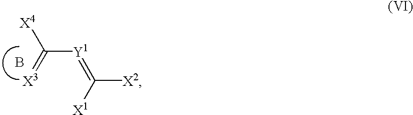
where
X¹ represents CN, CO—R¹, COO—R² or SO₂R¹,
X² represents hydrogen, methyl, ethyl, phenyl, 2- or 4-pyridyl, thiazol-2-110 yl, benzothiazol-2-yl, benzoxazol-2-yl, CN, CO—R¹, COO—R² or a radical of the formula 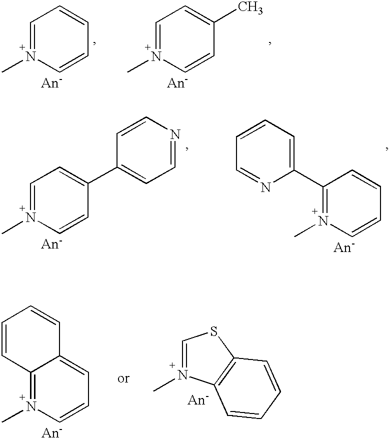
or
CX¹X² represents a ring of the formula 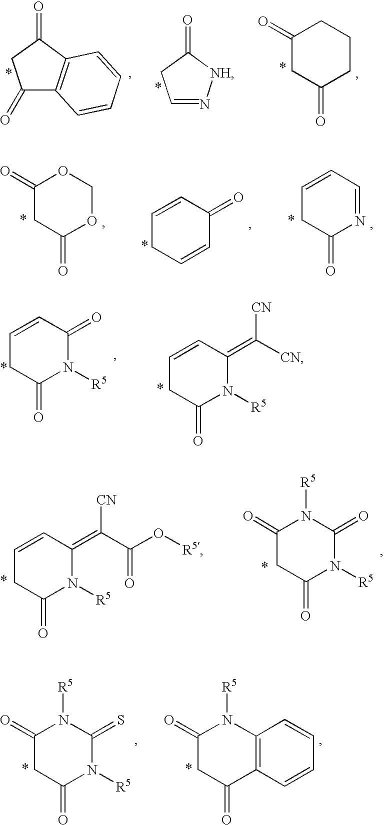
which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl, 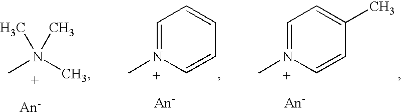
SO₃⁻M⁺, —CH₂—SO₃⁻M⁺,
where the asterisk (*) indicates the ring atom from which the double bond extends,
An⁻ represents an anion,
M⁺ represents a cation,
X³ represents CH,
X⁴ represents O, S or N—R⁶,
the ring B of the formula (II) represents furan-2-yl, thiophen-2-yl, pyrrol-2-yl or thiazol-5-yl, where the rings mentioned may each be substituted by methyl, ethyl, propyl, butyl, methoxy, ethoxy, fluorine, chlorine, bromine, cyano, nitro, methoxycarbonyl, ethoxycarbonyl, methylthio, ethylthio, phenoxy, tolyloxy, dimethylamino, diethylamino, dipropylamino, dibutylamino, N-methyl-N-phenylamino, pyrrolidino or morpholino,
Y¹ represents N or C—R⁷,
R¹, R², R⁵ and R⁶ represent, independently of one another, hydrogen, methyl, ethyl, propyl, butyl, pentyl, hexyl, phenyl or benzyl and
R⁵ may also represent —(CH₂)₃—N(CH₃)₂ or —(CH₂)₃—N⁺(CH₃)₃An⁻,
R^{5′} represents methyl, ethyl, propyl, butyl, pentyl, hexyl, phenyl or benzyl and
R⁷ represents hydrogen or cyano.

5. Optical data carrier according to one or more of claims 1 to 3, characterized in that the merocyanine dye has the formula (VII) 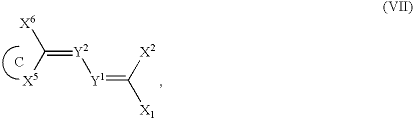
where
X¹ represents CN, CO—R¹, COO—R² or SO₂R¹,
X² represents hydrogen, methyl, ethyl, phenyl, 2- or 4-pyridyl, thiazol-2-yl, benzothiazol-2-yl, benzoxazol-2-yl, CN, CO—R¹, COO—R² or a radical of the formula 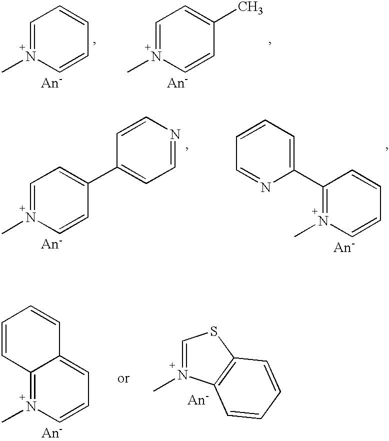
or
CX¹X² represents a ring of the formula 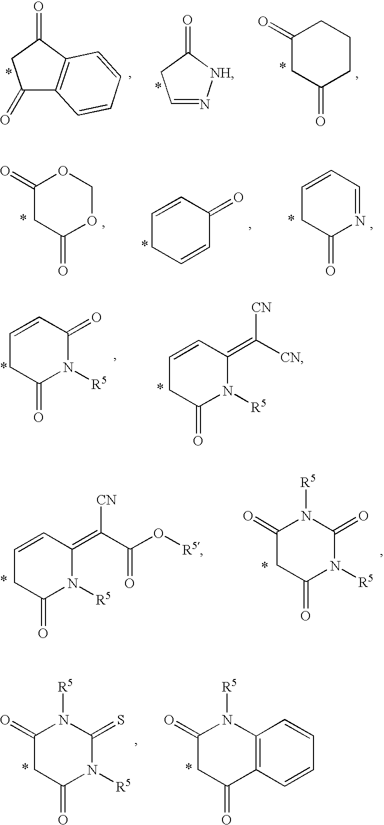
which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl, 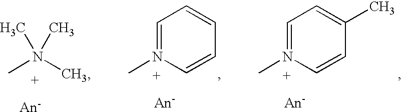
SO₃⁻M⁺, —CH₂—SO₃⁻M⁺,
where the asterisk (*) indicates the ring atom from which the double bond extends,
An⁻ represents an anion,
M⁺ represents a cation,
X⁵ represents N—R⁶,
X⁶ represents S, N—R⁶ or CH₂,
the ring C of the formula (V) represents benzothiazol-2-ylidene, benzimidazol-2-ylidene, thiazol-2-ylidene, thiazolin-2-ylidene, 1,3,4-thiadiazol-2-ylidene, 1,3,4-triazol-2-ylidene, dihydropyridin-4-ylidene, dihydroquinolin-4-ylidene, pyrrolin-2-ylidene or 3H-indol-2-ylidene, where the rings mentioned may each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,
Y²-Y¹ represents N—N or (C—R⁸)—(C—R⁷),
R¹, R², R⁵ and R⁶ represent, independently of one another, hydrogen, methyl, ethyl, propyl, butyl, pentyl, hexyl, phenyl or benzyl and
R⁵ may also represent —(CH₂)₃—N(CH₃)₂ or —(CH₂)₃—N⁺(CH₃)₃An⁻,
R^{5′} represents methyl, ethyl, propyl, butyl, pentyl, hexyl, phenyl or benzyl,
R⁷ and R⁸ represent hydrogen or
R⁶ and R⁸ together represent a —CH₂—CH₂— bridge.

6. Optical data carrier according to one or more of claims 1 to 3, characterized in that the merocyanine dye has the formula (VIII) 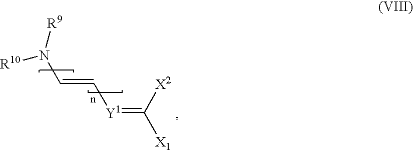
where
X¹ represents CN, CO—R¹, COO—R² or SO₂R¹,
X² represents hydrogen, methyl, ethyl, phenyl, 2- or 4-pyridyl, thiazol-2-yl, benzothiazol-2-yl, benzoxazol-2-yl, CN, CO—R¹, COO—R² or a radical of the formula 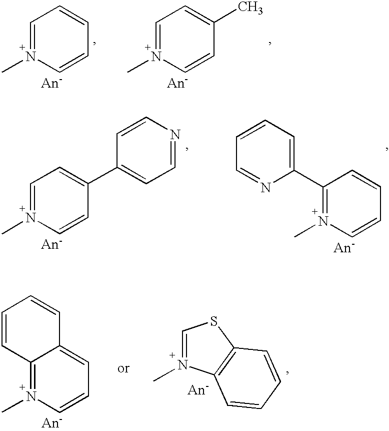
or
CX¹X² represents a ring of the formula 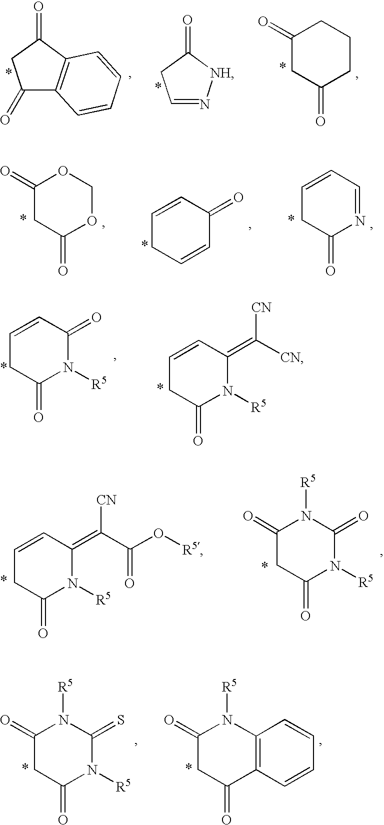
which may be substituted by up to 3 radicals selected from the group consisting of methyl, ethyl, methoxy, ethoxy, fluorine, chlorine, bromine, cyano, nitro, methoxycarbonyl, ethoxycarbonyl, phenyl, 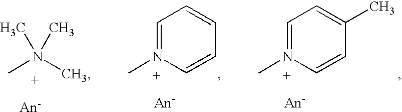
SO₃⁻M⁺, —CH₂—SO₃⁻M⁺,
where the asterisk (*) indicates the ring atom from which the double bond extends,
An⁻ represents an anion,
M⁺ represents a cation,
NR⁹R¹⁰ represents dimethylamino, diethylamino, dipropylamino, dibutylamino, N-methyl-N-phenylamino, N-ethyl-N-phenylamino, N-methyl-N-tolylamino, N-methyl-N-anisylamino, carbazolo, pyrrolidino, piperidino or morpholino,
Y¹ represents N or C—R⁷,
R¹, R², R⁵ and R⁶ represent, independently of one another, hydrogen, methyl, ethyl, propyl, butyl, pentyl, hexyl, phenyl or benzyl and
R⁵ may also represent —(CH₂)₃—N(CH₃)₂ or —(CH₂)₃—N⁺(CH₃)₃An⁻,
R^{5′} represents methyl, ethyl, propyl, butyl, pentyl, hexyl, phenyl or benzyl,
R⁷ represents hydrogen and
n represents 0 or 1.

7. Optical data carrier according to one or more of claims 1 to 6, characterized in that the merocyanine dye of the formula (I) has a solvent-induced wavelength shift Δλ of <20 nm, where Δλ=|λ_{DMF}−λ_{dioxane}|, viz. the positive difference between the absorption wavelengths in the solvents dimethylformamide and dioxane.

8. Optical data carrier according to one or more of claims 1 to 6, characterized in that the merocyanine dye has a dipole moment difference Δμ of <5 D, where Δμ=|μ_{g}−μₑₓ|, viz. the positive difference between the dipole moments in the ground state and the first excited state.

9. Use of merocyanines in the information layer of write-once optical data carriers, where the merocyanines have an absorption maximum λₘₐₓ₁ in the range from 340 to 410 nm, a λₘₐₓ₂ in the range from 420 to 650 nm or a λₘₐₓ₃ in the range from 650 to 810 nm.

10. Use of merocyanines in the information layer of write-once optical data carriers, where the data carriers are written on and read by means of blue laser light.

11. Process for producing the optical data carriers according to claim 1, which is characterized in that a preferably transparent substrate which may, if desired, have previously been coated with a reflection layer is coated with the merocyanines, if desired in combination with suitable binders and additives and, if desired, suitable solvents, and provided, if desired, with a reflection layer, further intermediate layers and, if desired, a protective layer or a further substrate or a covering layer.

12. Optical data carrier according to claim 1 which can be written on by means of blue, red or infrared light, in particular laser light.

13. Merocyanines of the formula (CI) 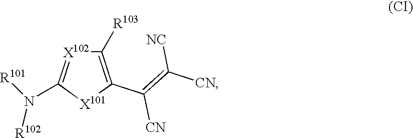
where
X¹⁰¹ represents O or S,
X¹⁰² represents CH,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen,
where the alkyl radicals such as propyl, butyl, etc., may be branched,
or the formula (CI) 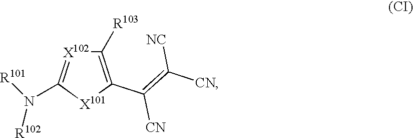
where
X¹⁰¹ represents S,
X¹⁰² represents N,
R¹⁰¹ and R¹⁰² represent, independently of one another, propyl, butyl, pentyl, hexyl, cyclohexyl, benzyl or phenyl and R¹⁰¹ may also be hydrogen or
NR¹⁰¹R¹⁰² represents pyrrolidino or piperidino,
R¹⁰³ represents hydrogen or phenyl,
where the alkyl radicals such as propyl, butyl, etc., may be branched,
or the formula (CXIV) 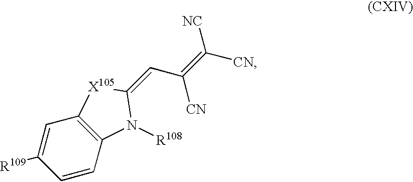
where
X¹⁰⁵ represents C(CH₃)₂,
R¹⁰⁸ represents propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents methyl, ethyl, methoxy, ethoxy, cyano, chlorine, trifluoromethyl, trifluoromethoxy or ethoxycarbonyl,
where the alkyl radicals such as propyl, butyl, etc., may be branched,
or the formula (CIII) 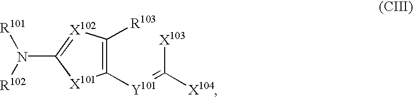
where
X¹⁰¹ represents O or S,
X¹⁰² represents N or CR^{104,}
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen or phenyl,
R¹⁰⁴ represents hydrogen or cyano,
Y¹⁰¹ represents CH,
CX¹⁰³X¹⁰⁴ represents a ring of the formula 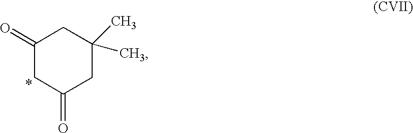
where the asterisk (*) indicates the ring atom from which the double bond extends,
where the alkyl radicals such as propyl, butyl, etc., may be branched,
or the formula (CIII) 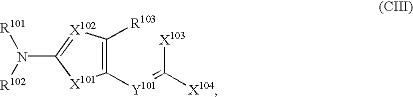
where
X¹⁰¹ represents O or S,
X¹⁰² represents N or CR¹⁰⁴,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,
R¹⁰⁴ represents hydrogen, methyl, ethyl, phenyl, chlorine, cyano, formyl or a radical of the formula 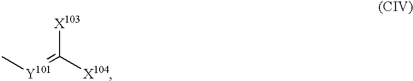
Y¹⁰¹ represents N or CH,
CX¹⁰³X¹⁰⁴ represents a ring of the formula 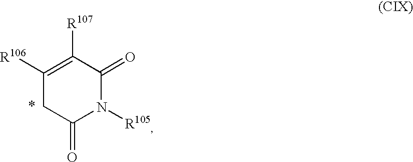
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or a radical of the formula 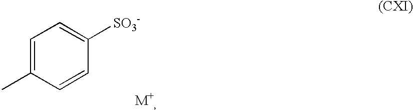
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents —CH₂SO₃⁻M⁺ or a radical of the formula 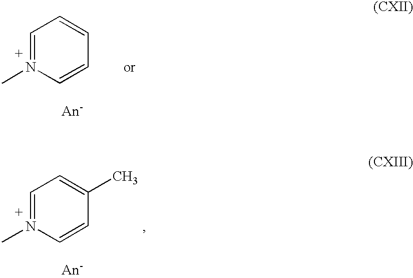
M⁺ represents a cation and
An⁻ represents an anion,
where the alkyl radicals such as propyl, butyl, etc., may be branched, or the formula (CIII) 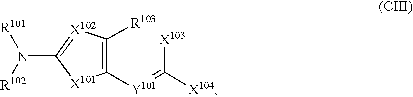
where
X¹⁰¹ represents O or S,
X¹⁰² represents CR¹⁰⁴
R¹⁰¹ and R¹⁰² represent, independently of one another, methyl, ethyl, propyl, cyclohexyl, benzyl or phenyl and R¹⁰¹ may also be hydrogen or
NR¹⁰¹R¹⁰² represents pyrrolidino or morpholino,
R¹⁰³ represents hydrogen, methyl or ethyl,
R¹⁰⁴ represents hydrogen, methyl or ethyl,
Y¹⁰¹ represents CH,
CX¹⁰³X¹⁰⁴ represents a ring of the formula 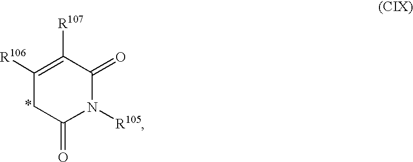
where the asterisk (*) indicates the ring atom from which the double bond extends,
R¹⁰⁵ represents hydrogen, methyl, ethyl, propyl, methoxyethyl, methoxypropyl, cyanoethyl, hydroxyethyl, acetoxyethyl, chloroethyl, cyclohexyl, phenyl, tolyl, methoxyphenyl, —(CH₂)₃—N(CH₃)₂, —(CH₂)₃—N⁺(CH₃)₃An⁻ or
a radical of the formula 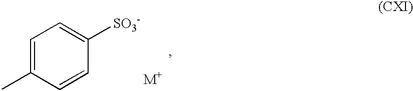
R¹⁰⁶ represents methyl, ethyl, propyl or butyl,
R¹⁰⁷ represents cyano, methoxycarbonyl or ethoxycarbonyl,
M⁺ represents a cation and
An⁻ represents an anion,
where the alkyl radicals such as propyl, butyl, etc., may be branched,
or the formula (CIII) 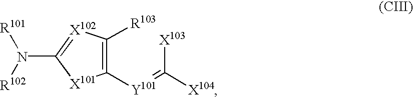
where
X¹⁰¹ represents O or S,
X¹⁰² represents N or CR¹⁰⁴,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,
R¹⁰⁴ represents hydrogen, methyl, ethyl, phenyl, chlorine, cyano, formyl or a radical of the formula 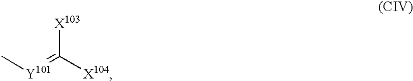
Y¹⁰¹ represents N or CH,
CX¹⁰³X¹⁰⁴ represents a ring of the formula 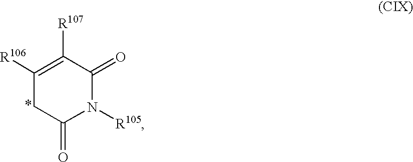
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 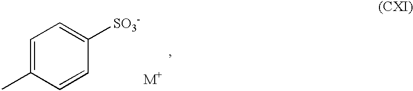
R¹⁰⁶ represents cyano, methoxycarbonyl or ethoxycarbonyl,
R¹⁰⁷ represents cyano, methoxycarbonyl or ethoxycarbonyl,
where the alkyl radicals such as propyl, butyl, etc., may be branched,
or the formula (CIII) 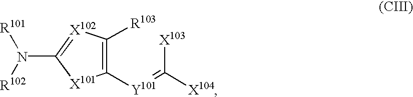
where
X¹⁰¹ represents O or S,
X¹⁰² represents N or CR¹⁰⁴,
R¹⁰¹ and R¹⁰² represent, independently of one another, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen or phenyl,
R¹⁰⁴ represents hydrogen or cyano,
Y¹⁰¹ represents CH,
CX¹⁰³X¹⁰⁴ represents a ring of the formula 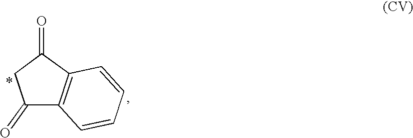
where the asterisk (*) indicates the ring atom from which the double bond extends,
where the alkyl radicals such as propyl, butyl, etc., may be branched,
or the formula (CIII) 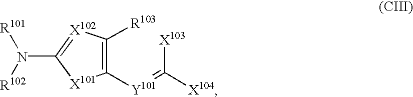
where
X¹⁰¹ represents O or S,
X¹⁰² represents N or CR¹⁰⁴,
R¹⁰¹ and R¹⁰² represent, independently of one another, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen or phenyl,
R¹⁰⁴ represents hydrogen or cyano,
Y¹⁰¹ represents CH,
CX¹⁰³X¹⁰⁴ represents a ring of the formula 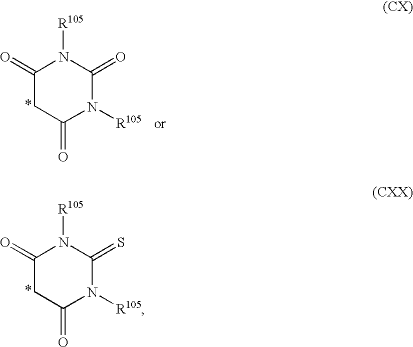
where the asterisk (*) indicates the ring atom from which the double bond extends,
R¹⁰⁵ represents propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl, —(CH₂)₃—N(CH₃)₂, —(CH₂)₃—N⁺(CH₃)₃An⁻ or
a radical of the formula 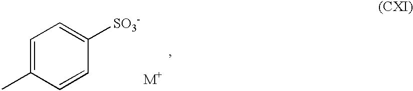
the two radicals R¹⁰⁵ may be different and
M⁺ represents a cation,
An⁻ represents an anion,
where the alkyl radicals such as propyl, butyl, etc., may be branched,
or the formula 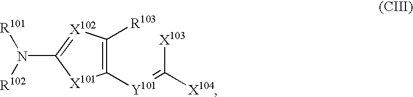
where
X¹⁰¹ represents O or S,
X¹⁰² represents N or CR¹⁰⁴,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,
R¹⁰⁴ represents hydrogen, methyl, ethyl, phenyl, chlorine, cyano, formyl or a radical of the formula 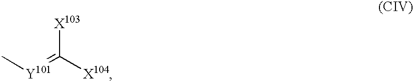
Y¹⁰¹ represents N or CH,
CX¹⁰³X¹⁰⁴ represents a ring of the formula 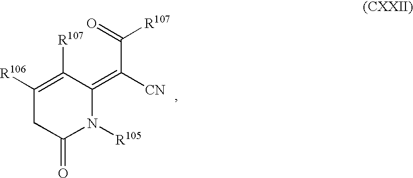
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents cyano, methoxycarbonyl, ethoxycarbonyl or a radical of the formula 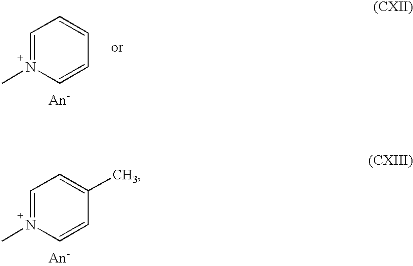
and
An⁻ represents an anion,
where the alkyl radicals such as propyl, butyl, etc., may be branched,
or the formula 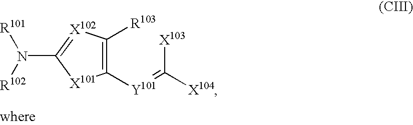
X¹⁰¹ represents O or S,
X¹⁰² represents N or CR¹⁰⁴,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,
R¹⁰⁴ represents hydrogen, methyl, ethyl, phenyl, chlorine, cyano, formyl or a radical of the formula 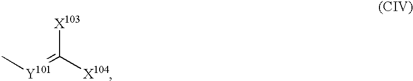
Y¹⁰¹ represents N or CH,
X¹⁰³ represents cyano, methoxycarbonyl or ethoxycarbonyl and
X¹⁰⁴ represents benzothiazol-2-yl, benzoxazol-2-yl or 2- or 4-pyridyl, where the alkyl radicals such as propyl, butyl, etc., may be branched,
or the formula 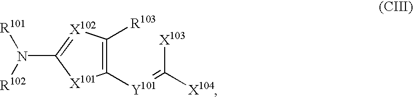
where
X¹⁰¹ represents O or S,
X¹⁰² represents N or CR¹⁰⁴,
R¹⁰¹ and R¹⁰² represent, independently of one another, methyl, ethyl, propyl, butyl, pentyl, hexyl, cyclohexyl, benzyl or phenyl and R¹⁰¹ may also be hydrogen or
NR¹⁰¹R¹⁰² represents pyrrolidino, piperidino or morpholino,
R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,
R¹⁰⁴ represents hydrogen, methyl, ethyl, phenyl, chlorine, cyano, formyl or a radical of the formula 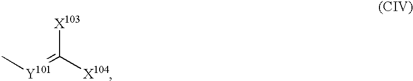
Y¹⁰¹ represents N or CH,
CX¹⁰³X¹⁰⁴ represents a radical of the formula 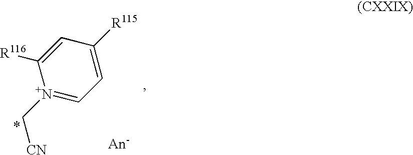
one of the radicals R¹¹⁵ and R¹¹⁶ represents hydrogen, methyl, cyano or 2- or 4-pyridyl and the other represents hydrogen, and
An⁻ represents an anion,
where the alkyl radicals such as propyl, butyl, etc., may be branched,
or the formula (CXVI) 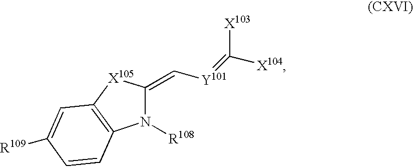
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a ring of the formula 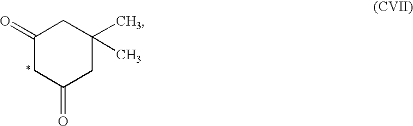
where the asterisk (*) indicates the ring atom from which the double bond extends,
where the alkyl radicals such as propyl, butyl, etc., may be branched,
or the formula (CXVI) 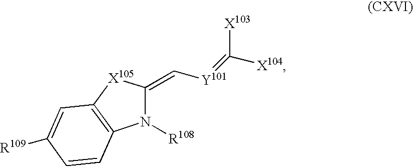
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a ring of the formula 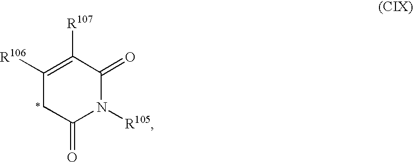
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 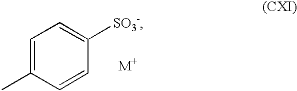
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents —CH₂SO₃⁻M⁺ or a radical of the formula 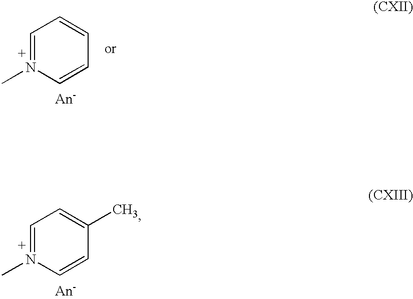
M⁺ represents a cation and
An⁻ represents an anion,
where the alkyl radicals such as propyl, butyl, etc., may be branched,
or the formula (CXVI) 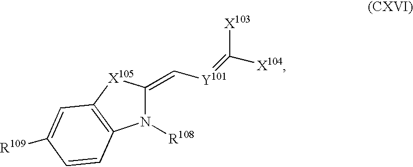
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a ring of the formula 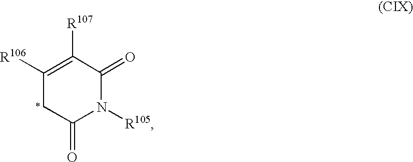
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 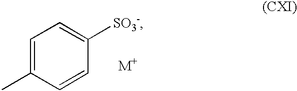
R¹⁰⁶ represents cyano, methoxycarbonyl or ethoxycarbonyl,
R¹⁰⁷ represents cyano, methoxycarbonyl or ethoxycarbonyl,
where the alkyl radicals such as propyl, butyl, etc., may be branched,
or the formula (CXVI) 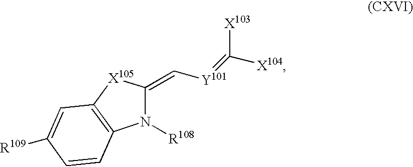
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a ring of the formula 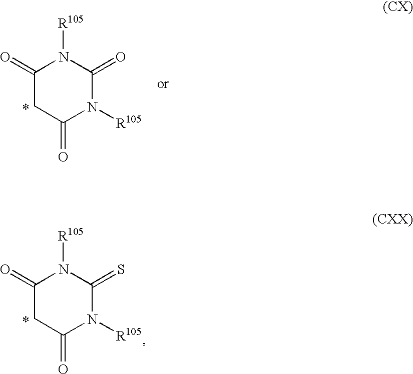
where the asterisk (*) indicates the ring atom from which the double bond extends,
R¹⁰⁵ represents propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl, CH₂)₃—N(CH₃)₂, —(CH₂)₃—N⁺(CH₃)₃An⁻ or
a radical of the formula 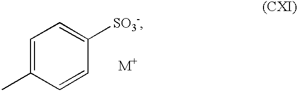
the two radicals R¹⁰⁵ may be different and
M⁺ represents a cation,
An⁻ represents an anion,
where the alkyl radicals such as propyl, butyl, etc., may be branched,
or the formula (CXVI) 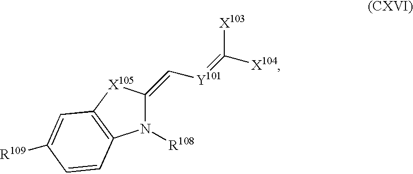
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a ring of the formula 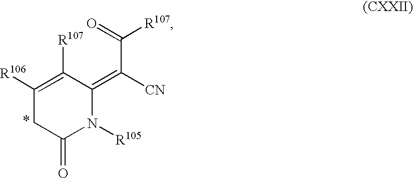
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents cyano, methoxycarbonyl, ethoxycarbonyl or a radical of the formula 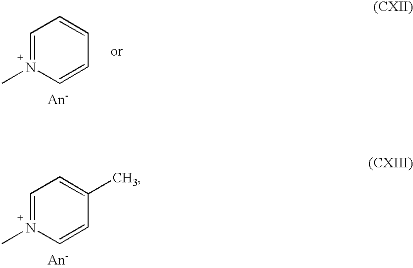
and
An⁻ represents an anion,
where the alkyl radicals such as propyl, butyl, etc., may be branched,
or the formula (CXVI) 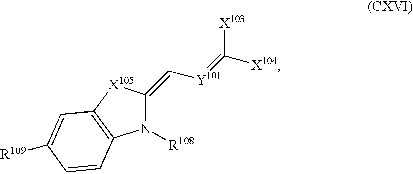
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
X¹⁰³ represents cyano, methoxycarbonyl or ethoxycarbonyl and
X¹⁰⁴ represents benzothiazol-2-yl, benzoxazol-2-yl or 2- or 4-pyridyl, preferably 2-pyridyl,
where the alkyl radicals such as propyl, butyl, etc., may be branched,
or the formula (CXVI) 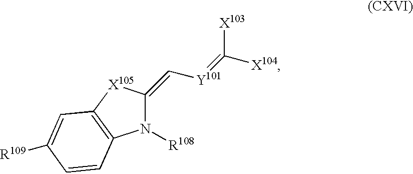
where
X¹⁰⁵ represents C(CH₃)₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
R¹⁰⁹ represents hydrogen, methyl, ethyl, methoxy, ethoxy, cyano, chlorine, trifluoromethyl, trifluoromethoxy, methoxycarbonyl or ethoxycarbonyl,
Y¹⁰¹ represents CH,
CX¹⁰³X¹⁰⁴ represents a radical of the formula 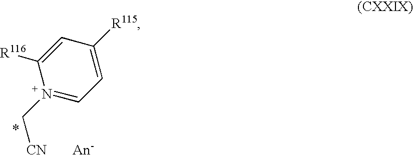
one of the radicals R¹¹⁵ and R¹¹⁶ represents hydrogen, methyl, cyano or 2- or 4-pyridyl and the other represents hydrogen, and
An⁻ represents an anion,
where the alkyl radicals such as propyl, butyl, etc., may be branched,
or the formula (CXIX) 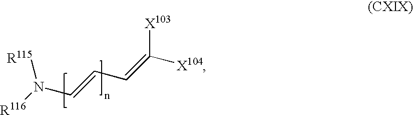
n represents 1 or 2,
or the formula (CXIX) 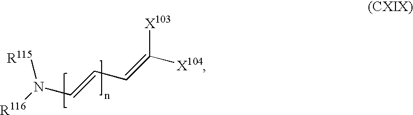
where
R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or
NR¹¹⁵R¹¹⁶ represents pyrrolidino, piperidino or morpholino,
n represents 1 or 2,
CX¹⁰³X¹⁰⁴ represents a ring of the formula 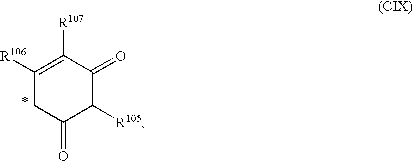
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 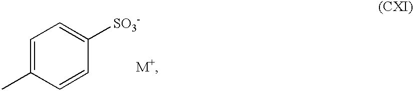
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents —CH₂SO₃⁻M⁺ or a radical of the formula 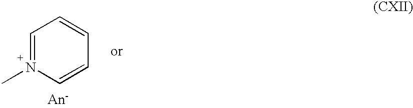 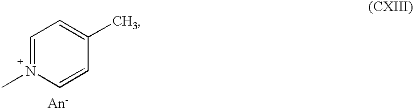
M⁺ represents a cation and
An⁻ represents an anion,
where the alkyl radicals such as propyl, butyl, etc., may be branched,
or the formula (CXIX) 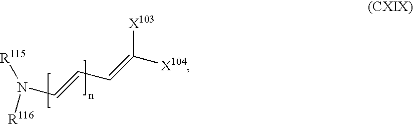
where
R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or
NR¹¹⁵R¹¹⁶ represents pyrrolidino, piperidino or morpholino,
n represents 1 or 2,
CX¹⁰³X¹⁰⁴ represents a ring of the formula 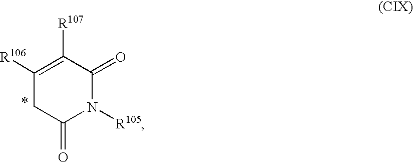
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 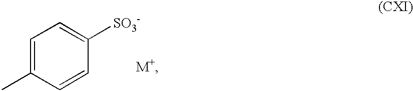
R¹⁰⁶ represents cyano, methoxycarbonyl or ethoxycarbonyl,
R¹⁰⁷ represents cyano, methoxycarbonyl or ethoxycarbonyl,
where the alkyl radicals such as propyl, butyl, etc., may be branched,
or the formula 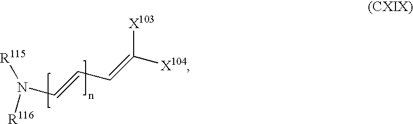
where
R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or
NR¹¹⁵R¹¹⁶ represents pyrrolidino, piperidino or morpholino,
n represents 1 or 2,
CX¹⁰³X¹⁰⁴ represents a ring of the formula 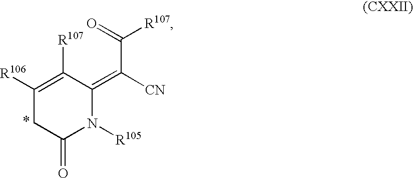
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents cyano, methoxycarbonyl, ethoxycarbonyl or a radical of the formula 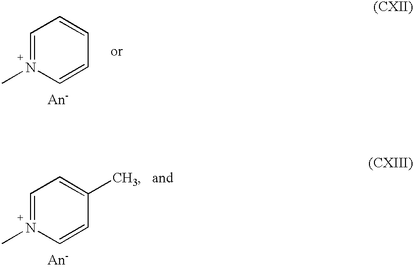
An⁻ represents an anion,
where the alkyl radicals such as propyl, butyl, etc., may be branched,
or the formula (CXIX) 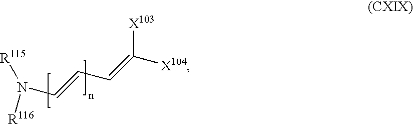
where
R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or
NR¹¹⁵R¹¹⁶ represents pyrrolidino, piperidino or morpholino,
n represents 1 or 2,
X¹⁰³ represents cyano, methoxycarbonyl or ethoxycarbonyl and
X¹⁰⁴ represents benzothiazol-2-yl, benzoxazol-2-yl or 2- or 4-pyridyl, preferably 2-pyridyl,
where the alkyl radicals such as propyl, butyl, etc., may be branched,
or the formula (CXIX) 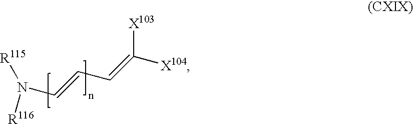
where
R¹¹⁵ and R¹¹⁶ represent, independently of one another, methyl, ethyl, propyl, butyl, pentyl, hexyl, heptyl, octyl, phenyl, tolyl, anisyl, benzyl or phenethyl or
NR¹¹⁵R¹¹⁶ represents pyrrolidino, piperidino or morpholino,
n represents 1 or 2,
CX¹⁰³X¹⁰⁴ represents a radical of the formula 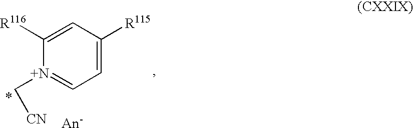
one of the radicals R¹¹⁵ and R¹¹⁶ represents hydrogen, methyl, cyano or 2- or 4-pyridyl and the other represents hydrogen, and
An⁻ represents an anion,
where the alkyl radicals such as propyl, butyl, etc., may be branched,
or the formula (CXXXI) 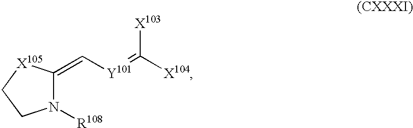
where
X¹⁰⁵ represents O, S or CH₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
Y¹⁰¹ represents CH,
CX¹⁰³X¹⁰⁴ represents a ring of the formula 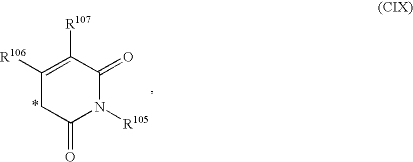
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 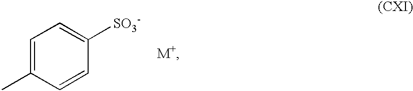
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents —CH₂SO₃⁻M⁺ or a radical of the formula 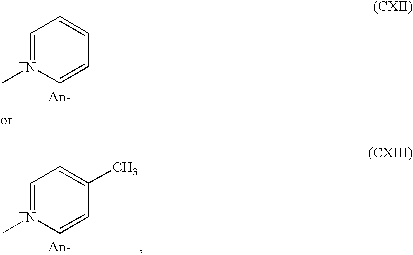
M⁺ represents a cation and
An⁻ represents an anion,
where the alkyl radicals such as propyl, butyl, etc., may be branched,
or the formula (CXXXI) 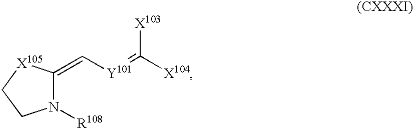
where
X¹⁰⁵ represents O, S or CH₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
Y¹⁰¹ represents CH,
CX¹⁰³X¹⁰⁴ represents a ring of the formula 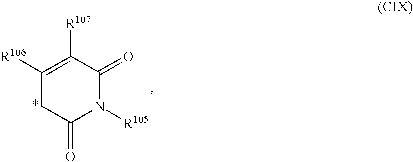
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or
a radical of the formula 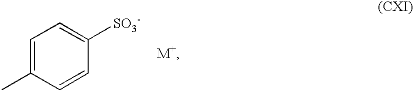
R¹⁰⁶ represents cyano, methoxycarbonyl or ethoxycarbonyl,
R¹⁰⁷ represents cyano, methoxycarbonyl or ethoxycarbonyl,
where the alkyl radicals such as propyl, butyl, etc., may be branched,
or the formula (CXXXI) 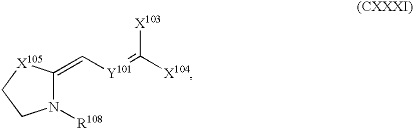
where
X¹⁰⁵ represents O, S or CH₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
Y¹⁰¹ represents CH,
CX¹⁰³X¹⁰⁴ represents a ring of the formula 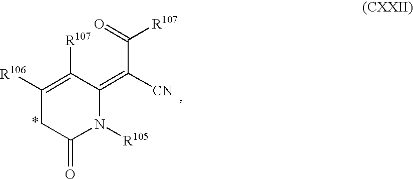
where the asterisk (*) indicates the ring atom from which the double bond extends,
R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl or methoxyphenyl,
R¹⁰⁶ represents hydrogen, methyl, ethyl, propyl, butyl, trifluoromethyl, cyano, methoxycarbonyl, ethoxycarbonyl, cyclohexyl or phenyl,
R¹⁰⁷ represents cyano, methoxycarbonyl, ethoxycarbonyl or a radical of the formula 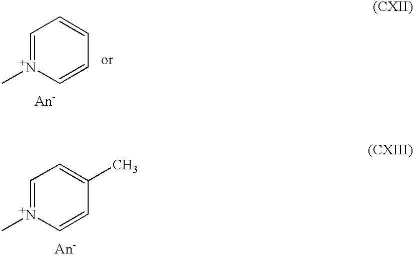
and
An⁻ represents an anion,
where the alkyl radicals such as propyl, butyl, etc., may be branched,
or the formula (CXXXI) 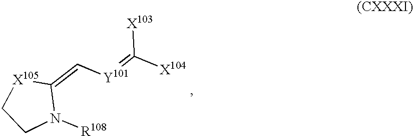
where
X¹⁰⁵ represents O, S or CH₂,
R¹⁰⁸ represents methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, benzyl or phenethyl,
Y¹⁰¹ represents CH,
X¹⁰³ represents cyano, methoxycarbonyl or ethoxycarbonyl and
X¹⁰⁴ represents benzothiazol-2-yl, benzoxazol-2-yl or 2- or 4-pyridyl, preferably 2-pyridyl,
where the alkyl radicals such as propyl, butyl, etc., may be branched,
or the formula (CXXXI) 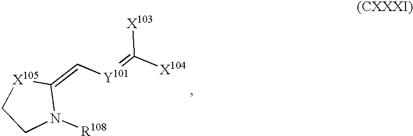
where
X¹⁰⁵ represents O, S or CH₂,
R¹⁰⁸ represents methyl, ethyl, propyl, butyl, pentyl, hexyl, heptyl, octyl, methoxyethyl methoxypropyl, cyanoethyl, hydroxyethyl, acetoxyethyl, chloroethyl, cyclohexyl, benzyl or phenethyl,
Y¹⁰¹ represents CH,
CX¹⁰³X¹⁰⁴ represents a radical of the formula 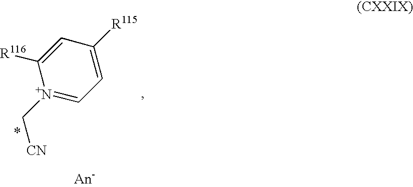
one of the radicals R¹¹⁵ and R¹¹⁶ represents hydrogen, methyl, cyano or 2- or 4-pyridyl and the other represents hydrogen, and
An⁻ represents an anion,
where the alkyl radicals such as propyl, butyl, etc., may be branched.
